(19) United States
(12) Patent Application Publication
(10) Pub. No.: US 2007/0148464 A1
(43) Pub. Date: Jun. 28, 2007

(54) Display apparatus

(76) Inventors: Etsuko Nishimura, Hitachiota (JP); Takuya Takahashi, Hitachi (JP); Takaaki Suzuki, Kasama (JP); Toshiaki Kusunoki, Tokorozawa (JP); Masakazu Sagawa, Inagi (JP); Naohiro Horiuchi, Hitachi (JP); Nobuhiko Fukuoka, Ebina (JP); Nobuyuki Ushifusa, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/640,872

(22) Filed: Dec. 19, 2006

(30) Foreign Application Priority Data
Dec. 22, 2005 (JP) 2005-369719

(51) Int. Cl. B32B 17/10

(52) U.S. Cl. 428/409

(57) ABSTRACT

Although sintered wire with lower resistance was preferable as a scan line and a signal line in conventional art in order to make a voltage drop small, there was a problem in electric connection with an electrode which constructs a cathode. In the present invention, a cathode which has an electron-emitting region 16 on a substrate 10 is constructed of a base electrode 11, a top electrode 13, and a protective insulating film 14 sandwiched by these electrodes, the base electrode 11 becomes a signal line, and sintered wire 18, used as a scan line, and the top electrode 13 are connected with an sub-electrode 17. The sub-electrode 17 includes metal included in the sintered wire 18, and metal included in the top electrode 13.

### BACKGROUND OF THE INVENTION

(1) Field of the Invention

The present invention relates to a display apparatus having active devices, and in particular, relates to a display apparatus using a self-light-emitting thin-film electron-emitter array.

(2) Description of Related Art

A display using a very small and integrable cold cathode is called an FED (Field Emission Display). A cold cathode is classified into a field emission type cathode and a hot electron type cathode. A Spindt type cathode, a surface conduction cathode, a carbon nanotube type cathode, and the like belong to the former. In the latter, there are thin film cathodes such as an MIM (Metal-Insulator-Metal) type one in which metal, an insulator, and metal are stacked, an MIS (Metal-Insulator-Semiconductor) type one in which metal, an insulator, and a semiconductor are stacked, and a metal-insulator-semiconductor-metal type one.

When performing image display in an FED, a driving method called a line-sequential driving system is generally adopted. This is a system which performs display in each frame every scan line (in a horizontal direction) when displaying a still image at 60 frames per second. Hence, all the cathodes corresponding to the number of signal lines on the same scan line operate at the same time.

A current obtained by multiplying a current, which a cathode included in a subpixel consumes, by the number of full signal lines flows into a scan line at the time of an operation. Since this scan line current causes a voltage drop along the scan line by wire resistance, it obstructs a uniform operation of the cathodes. In particular, when achieving a large display unit, the voltage drop by the wire resistance of a scan line is a large problem.

Also in the case of a signal line, a voltage drop by wire resistance is not desirable because of causing operational delay in a direction of signal lines of the cathodes on the same signal line.

For solving this problem, it is necessary to reduce the wire resistance of a scan line and a signal line. In the case of a thin film cathode, it is conceivable to make a bus electrode for feeding a pair of element electrodes (as an example, these are equivalent to a base electrode and a top electrode of a MIM element when it is an MIM type cathode), which construct a cathode, lower resistance. About the MIM type cathode, JP-A-10-153979 (patent document 1) discloses, for example.

In order to lower wire resistance of the bus electrode, it is effective to use a material which has small specific resistance and is easy to be made a thick film. Sintered wire which is made of low resistance metal such as Ag, Pd, Pt, or Au has small specific resistance, and is easy to be made a thick film. In addition, it is advantageous also from an aspect of cost reduction since it is possible to directly form an arbitrary wire pattern by screen printing using metal paste, an ink jet method using metal ink, and a photolithography method using photosensitive metal paste. In addition, it is desirable also at a point that it is possible to form a pattern of such metal that processing by usual wet etching and dry etching is difficult.

In addition, JP-A-2000-251680 (patent document 2) discloses a display apparatus where a first conductor layer and an inter-layer insulating film are embedded in a trench formed in a substrate, a second conductor layer which intersects the first conductor layer is formed thereon, the first conductor layer is connected to an electrode near an electron-emitting region, formed on the substrate, through a step with the trench, and a protrusion pattern for ensuring contact is provided in the step section.

It is necessary to secure electric connection between an element electrode and a bus electrode of a cathode in a sufficient yield. However, as for sintered wire, since wire is formed by melting and sticking metal grains, included in metal paste or metal ink, by sintering after coating the metal paste or metal ink, convexoconcave of a wire surface and pattern edges becomes remarkable easily, and also as for a form of a pattern edge, it is hard to obtain a tapered shape advantageous to electrode connection. Therefore, there is a problem of being poor in connection reliability such as increase of junction resistance, and easy disconnection, and when sintered wire is made a thick film for lower resistance, it tends to become obvious.

Although a heat process for sintering is necessary in order to form such sintered wire, it is easy to generate surface oxidization on an element electrode, which is a connection partner, by heat treatment, and hence, there is a problem that connection characteristics drop further. In addition, sintered wire has a task also in sticking property and tends to generate peeling of an electrode. Hence, in the case of using sintered wire as a wire material, it is necessary to solve such tasks.

Then, the present invention aims at providing a display apparatus which can secure connection with electrodes of cathodes even if sintered wire easily having low resistance by a thick film is used, and which is hardly influenced by a voltage drop.

In addition, besides the above, the present invention aims at providing a technique of achieving lower resistance of wire in a display apparatus in which a plurality of wire and active devices are formed on a substrate.

### BRIEF SUMMARY OF THE INVENTION

The present invention is equipped with a plurality of first parallel wires formed on a substrate, a plurality of second parallel wires which intersects the first parallel wire, and a plurality of active devices connected to crossings of the first parallel wire and second parallel wire, and is characterized in that either or both of the first parallel wire and second parallel wire are constructed of sintered wire, and that a sub-layer which includes at least a metal which constructs the sintered wire is formed in a connection interface between the sintered wire and electrodes of an active device.

The sintered wire is made of low resistance metal such as Ag, Pd, Pt, or Au, and is formed by melting and sticking, and sintering microparticles by heat treatment after directly forming a pattern of parallel wire using metal paste or metal ink including metal microparticles at several nm to several μm of diameter. A sub-layer which includes a metal which constructs the sintered wire is formed in a connection interface between the sintered wire and electrodes (element electrodes) of the active device.

In the heat process for forming sintered wire, interdiffusion of metals which construct sintered wire arises between a sub-layer including the metal which constructs sintered wire, and metal microparticles which become a base of sintered wire. The interdiffused metals are promoted in melting and sticking, and crystallization in the interface, and junctions the sintered wire and element electrodes precisely. Thereby, it is possible to secure the electric connection between the sintered wire and element electrodes, and to secure also sticking property of the sintered wire itself.

On the other hand, the metal such as Ag, Pd, Pt, or Au which constructs the sintered wire is metal which is hardly oxidized. Hence, since an element electrode surface is coated with a sub-layer including the metal, which is hardly oxidized, by forming the sub-layer including the metal which constructs the sintered wire in a connection interface with an element electrode, it is also possible to suppress surface oxidization of the element electrode itself. In addition, it is possible to reduce an influence itself of a surface oxide film of the element electrode by interdiffusion of the metal which constructs the sintered wire over the surface oxide film.

It is also possible to obtain an operation similar to the above also by providing a sub-electrode which is made of the metal, which constructs the sintered wire, or metal including the metal, which constructs the sintered wire, for connection between the above-mentioned sintered wire and element electrode.

As an example of parent metal of the metal which constructs the above-mentioned sub-electrode, metal which constructs the element electrode from a point of securing process consistency such as bondability with the element electrode, and processability, for example, aluminum, or an aluminum alloy is desirable. When it is necessary to secure further thermal oxidation resistance for heat treatment in high temperature, and the like, metal which resists the thermal oxidation, for example, Ni, Cr, Mo, Ti, Ta, W, and Co, or an alloy including them is desirable.

In addition, in a display apparatus in which a plurality of cathodes provided on a substrate, feeding wire which is constructed of signal lines and scan lines for feeding the electrodes of the cathodes, and sub-electrodes for connecting the feeding wire and the electrodes of the cathodes are provided, it is possible to obtain an operation similar to the above by that at least one side of the feeding wire is constructed of sintered wire, and connection interfaces between the sintered wire and sub-electrodes are metal films which include at least metal which constructs the sintered wire.

It is also possible to obtain an operation similar to the above also by making the sub-electrode a metal film which is constructed of metal, which constructs the sintered wire, or metal including the metal which constructs the sintered wire. Alternatively, it is also possible to obtain an operation similar to the above also by making the electrode, which is connected to the feeding wire, a metal film which is constructed of metal, which constructs the sintered wire, or metal including the metal.

As mentioned above, the present invention can provide a display apparatus which can secure electric connection and sticking property with electrodes of cathodes even if sintered wire easily having low resistance by a thick film is used, and which is hardly influenced by a voltage drop.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIGS. 1(a), 1(b), and 1(c) are diagrams showing a first embodiment of thin film cathodes according to the present invention;

FIGS. 2(a), 2(b), and 2(c) are diagrams showing a production method of the thin film cathodes shown in FIGS. 1(a), 1(b), and 1(c);

FIGS. 3(a), 3(b), and 3(c) are diagrams showing the production method of the thin film cathodes shown in FIGS. 1(a), 1(b), and 1(c);

FIGS. 4(a), 4(b), and 4(c) are diagrams showing the production method of the thin film cathodes shown in FIGS. 1(a), 1(b), and 1(c);

FIGS. 5(a), 5(b), and 5(c) are diagrams showing the production method of the thin film cathodes shown in FIGS. 1(a), 1(b), and 1(c);

FIGS. 6(a), 6(b), and 6(c) are diagrams showing the production method of the thin film cathodes shown in FIGS. 1(a), 1(b), and 1(c);

FIGS. 7(a), 7(b), and 7(c) are diagrams showing the production method of the thin film cathodes shown in FIGS. 1(a), 1(b), and 1(c);

FIGS. 8(a), 8(b), and 8(c) are diagrams showing the production method of the thin film cathodes shown in FIGS. 1(a), 1(b), and 1(c);

FIGS. 9(a), 9(b), and 9(c) are diagrams showing the production method of the thin film cathodes shown in FIGS. 1(a), 1(b), and 1(c);

FIGS. 10(a), 10(b), and 10(c) are diagrams showing the production method of the thin film cathodes shown in FIGS. 1(a), 1(b), and 1(c);

FIG. 11 is a diagram showing an embodiment of a display apparatus using the thin film cathodes according to the present invention;

FIGS. 12(a), 12(b), and 12(c) are diagrams showing a second embodiment of thin film cathodes according to the present invention;

FIGS. 13(a), 13(b), and 13(c) are diagrams showing a third embodiment of thin film cathodes according to the present invention;

FIGS. 14(a), 14(b), and 14(c) are diagrams showing a fourth embodiment of thin film cathodes according to the present invention;

FIGS. 15(a), 15(b), and 15(c) are diagrams showing a production method of thin film cathodes shown in FIGS. 14(a), 14(b), and 14(c);

FIGS. 16(a), 16(b), and 16(c) are diagrams showing the production method of thin film cathodes shown in FIGS. 14(a), 14(b), and 14(c);

FIGS. 17(a), 17(b), and 17(c) are diagrams showing the production method of thin film cathodes shown in FIGS. 14(a), 14(b), and 14(c);

FIGS. 18(a), 18(b), and 18(c) are diagrams showing the production method of thin film cathodes shown in FIGS. 14(a), 14(b), and 14(c);

FIGS. 19(a), 19(b), and 19(c) are diagrams showing the production method of thin film cathodes shown in FIGS. 14(a), 14(b), and 14(c);

FIGS. 20(a), 20(b), and 20(c) are diagrams showing the production method of thin film cathodes shown in FIGS. 14(a), 14(b), and 14(c);

FIGS. 21(a), 21(b), and 21(c) are diagrams showing a fifth embodiment of thin film cathodes according to the present invention;

FIGS. 22(a), 22(b), and 22(c) are diagrams showing a production method of the thin film cathodes shown in FIGS. 21(a), 21(b), and 21(c);

FIGS. 23(a), 23(b), and 23(c) are diagrams showing a sixth embodiment of thin film cathodes according to the present invention;

FIGS. 24(a), 24(b), and 24(c) are diagrams showing a production method of the thin film cathodes shown in FIGS. 23(a), 23(b), and 23(c);

FIGS. 25(a), 25(b), and 25(c) are diagrams showing the production method of the thin film cathodes shown in FIGS. 23(a), 23(b), and 23(c);

FIGS. 26(a), 26(b), and 26(c) are diagrams showing the production method of the thin film cathodes shown in FIGS. 23(a), 23(b), and 23(c);

FIGS. 27(a), 27(b), and 27(c) are diagrams showing the production method of the thin film cathodes shown in FIGS. 23(a), 23(b), and 23(c);

FIGS. 28(a), 28(b), and 28(c) are diagrams showing the production method of the thin film cathodes shown in FIGS. 23(a), 23(b), and 23(c);

FIGS. 29(a), 29(b), and 29(c) are diagrams showing the production method of the thin film cathodes shown in FIGS. 23(a), 23(b), and 23(c);

FIGS. 30(a), 30(b), and 30(c) are diagrams showing the production method of the thin film cathodes shown in FIGS. 23(a), 23(b), and 23(c);

FIGS. 31(a), 31(b), and 31(c) are diagrams showing a seventh embodiment of thin film cathodes according to the present invention;

FIGS. 32(a), 32(b), and 32(c) are diagrams showing a production method of the thin film cathodes shown in FIGS. 31(a), 31(b), and 31(c);

FIGS. 33(a), 33(b), and 33(c) are diagrams showing an eighth embodiment of thin film cathodes according to the present invention; and

FIGS. 34(a), 34(b), and 34(c) are diagrams showing a production method of the thin film cathodes shown in FIGS. 33(a), 33(b), and 33(c).

### DESCRIPTION OF REFERENCE NUMERALS

10 . . . substrate, 11 . . . base electrode, 12 . . . insulating layer, 13 . . . top electrode, 14 . . . protective insulation layer, 15 . . . interlayer insulating film, 17, 17a, and 17b . . . sub-electrodes, 18 . . . sintered wire, 19 . . . scan line (sintered wire), 20 . . . inter-layer insulating film (dielectric), 22 . . . signal line (sintered wire), 23 . . . protective electrode of sub-electrode, 24 . . . protective electrode of scan line (sintered wire), 25 . . . resist film, 30 . . . spacer, 50 . . . signal line drive circuit, 60 . . . scanning line drive circuit, 111 . . . red phosphor, 112 . . . green phosphor, 113 . . . blue phosphor, 120 . . . black matrix, C . . . connection region of sub-electrode and sintered wire (scan line), D . . . connection region of sub-electrode and element electrode (top electrode), E . . . connecting region of sub-electrode and sintered wire (signal line), F . . . connection region of sub-electrode and element electrode (base electrode)

### DETAILED DESCRIPTION OF THE INVENTION

Hereafter, respective embodiments of the present invention will be described with referring to drawings.

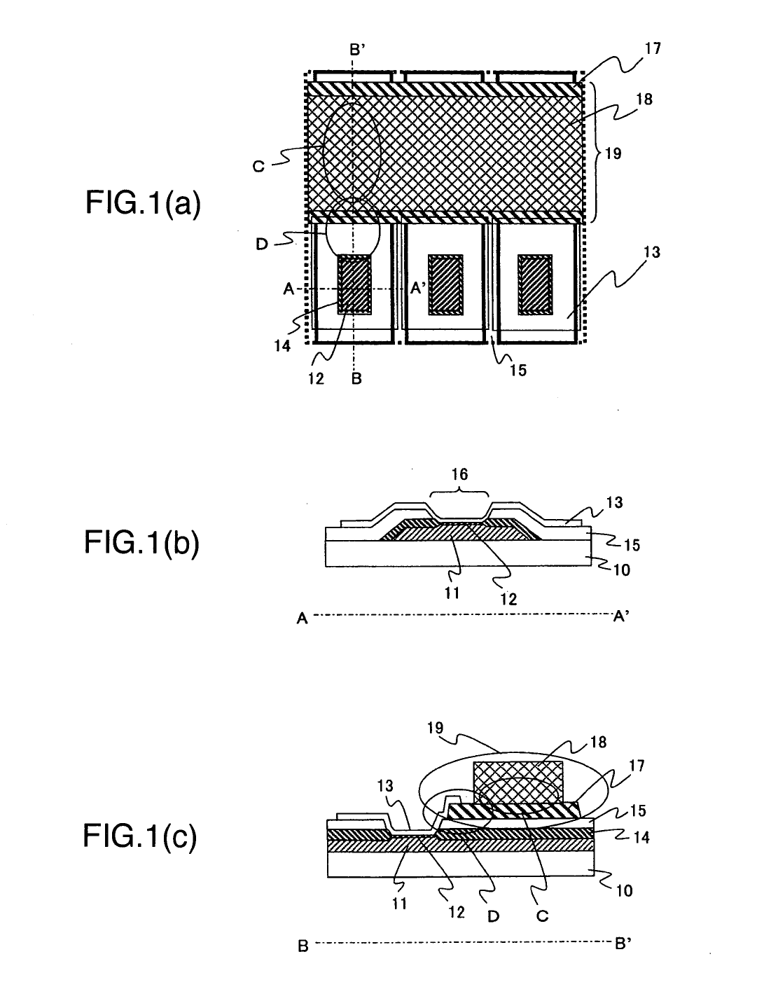

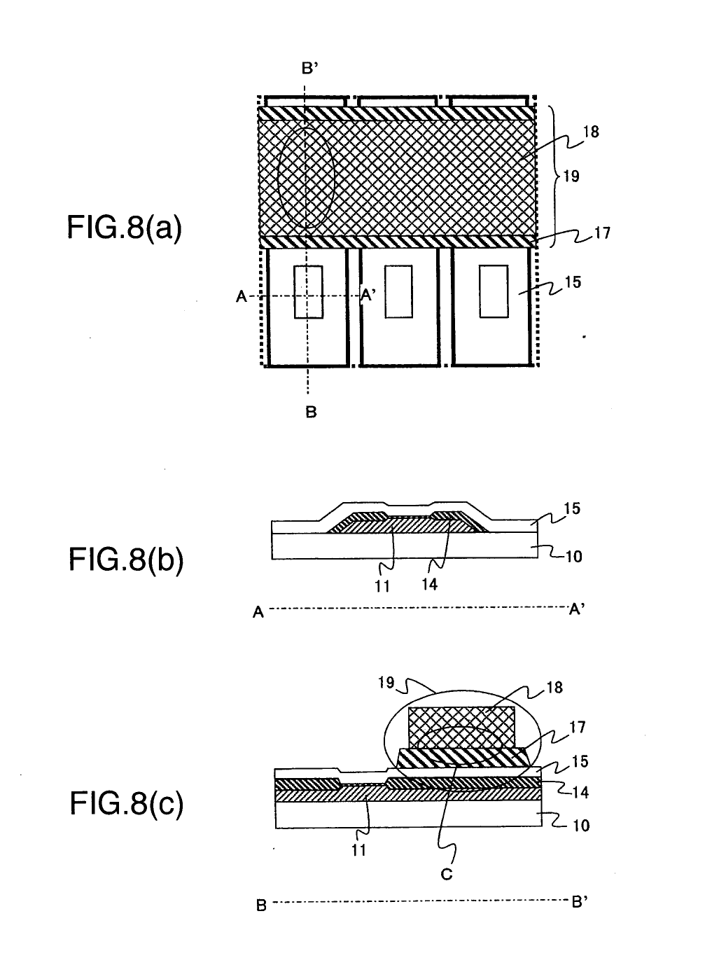

A first embodiment of the present invention will be explained using FIGS. 1 to 10 with using an MIM cathode as an example. In these diagrams, top views are shown in Fig. xx(a), sectional views taken on line A-A in top views in Fig. xx(a) are shown in Fig. xx(b), and sectional views taken on line B-B′ are shown in Fig. xx(c). In this embodiment, a scan line 19 in which sintered wire 18 is stacked on a sub-electrode 17 is formed.

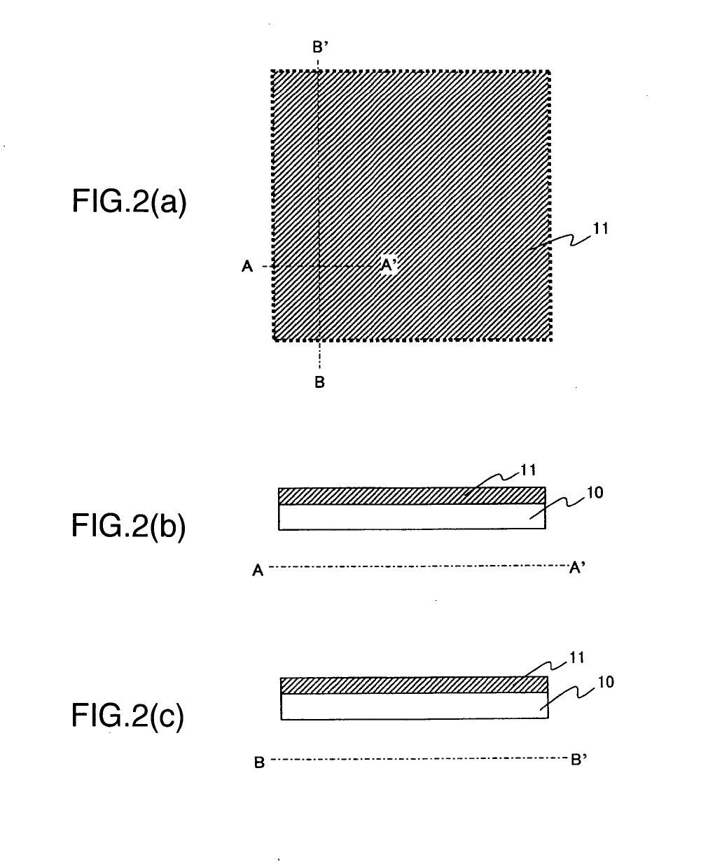

First, a metal film for a base electrode 11 which is an element electrode of the MIM element is formed on an insulative substrate 10, such as glass (FIGS. 2(a) to 2(c)). Al or an Al alloy is used as a material of the base electrode 11. The Al or Al alloy is used because a good insulator is formed by anodic oxidation. Here, an Al—Nd alloy in which 2 atomic weight % of Nd is doped is used. For film formation, for example, a sputtering method is used. In this embodiment, the base electrode 11 is made to serve also as a signal line as it is. A film thickness is made to be 300 nm.

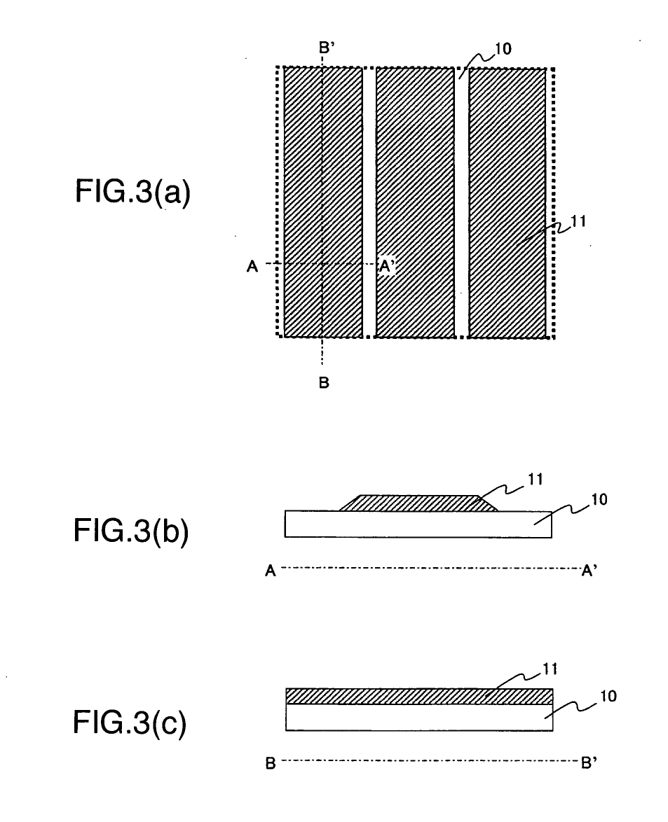

After film formation, a stripe-shaped base electrode 11 is formed by a photoresist patterning process and an etching process (FIGS. 3(a) to 3(c)). Although an electrode width changes with sizes and resolution of a display apparatus, it is made to be an extent of a subpixel pitch, that is, about 100 to 200 μm. In etching, for example, wet etching in a mixed water solution of phosphoric acid, acetic acid, or nitric acid is used. Since this electrode has wide and simple stripe geometry, it is possible to pattern a resist by inexpensive proximity exposure, a printing method, or the like.

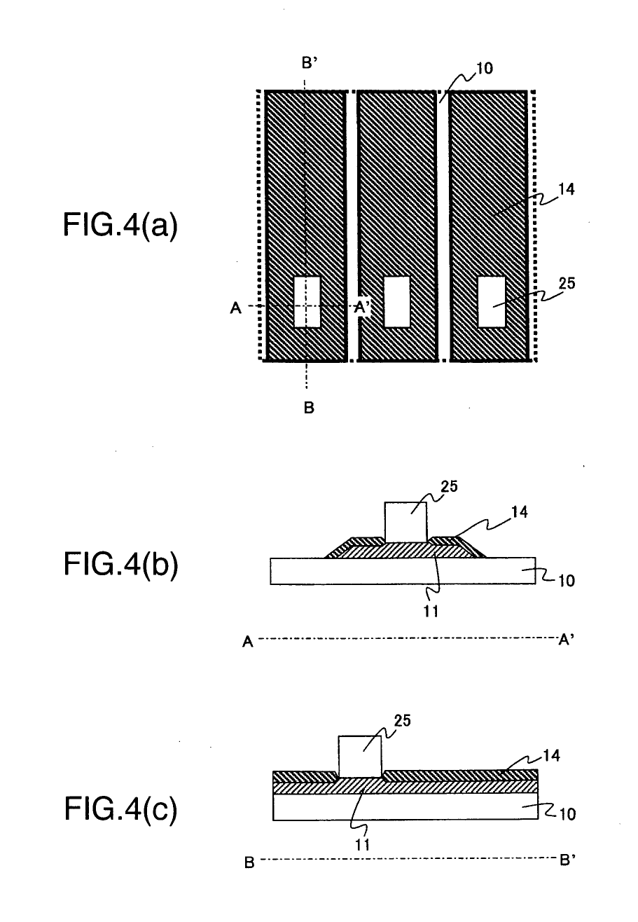

Next, a protective insulation layer 14, which limits an electron-emitting region 16 and prevents electric field concentration to edges of the base electrode 11 of an element, and an insulator 12 are formed. First, a portion used as the electron-emitting region 16 on the base electrode 11 is masked with a resist film 25, and another portion is selectively anodized thickly, which is made the protective insulation layer 14 (FIGS. 4(a) to 4(c)). When an anodization voltage is 100 V, the protective insulation layer 14 about 136 nm thick is formed.

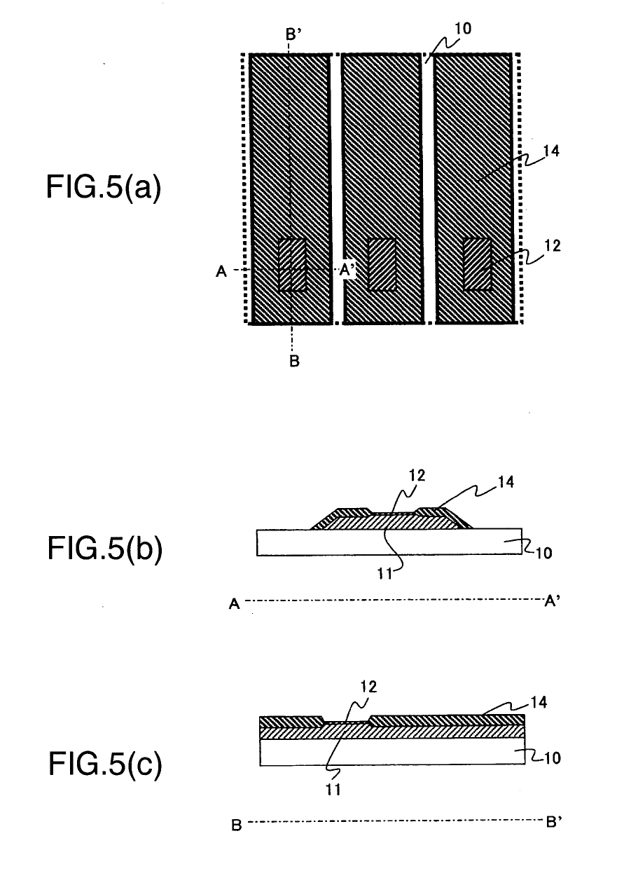

Subsequently, the resist film 25 is removed and a surface of the remaining base electrode 11 is anodized. For example, when an anodization voltage is 6 V, the insulator 12 which is an electronic acceleration layer about 10 nm thick is formed on the base electrode 11 (FIGS. 5(a) to 5(c)).

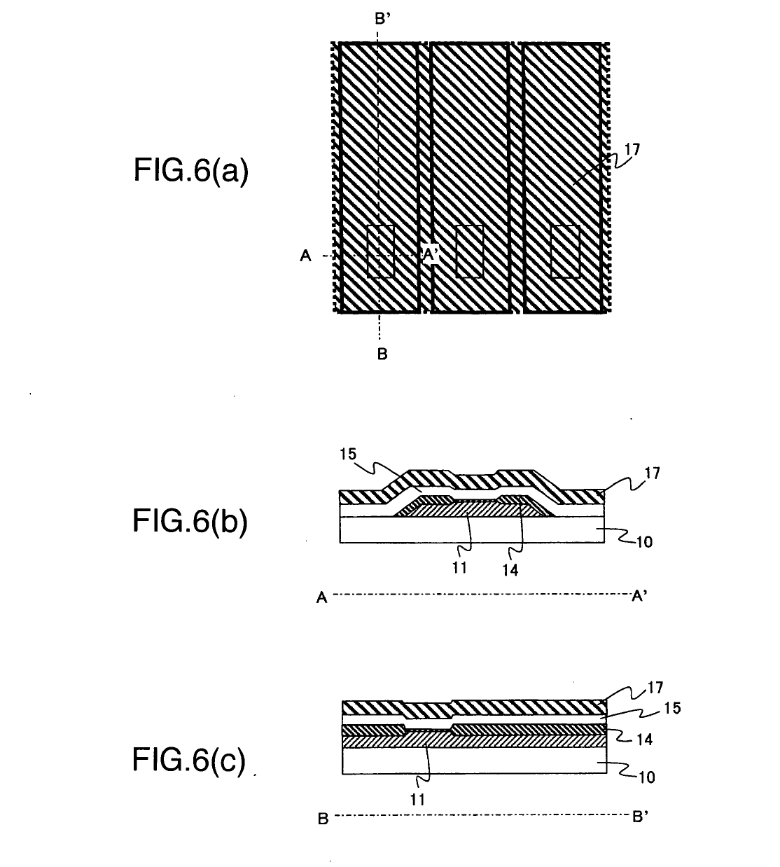

Next, as a film as the inter-layer insulating film 15, for example, a silicon oxide film, a silicon nitride film, a silicon film, is formed (FIGS. 6(a) to 6(c)). When a pinhole is in the protective insulation layer 14 formed by anodic oxidation, this inter-layer insulating film 15 buries the defect, and plays a role of keeping insulation between the base electrode 11 and sub-electrode 17. Here, a film thickness is made to be 100 nm using a silicon nitride film formed by the sputtering method. Then, the sub-electrode 17 which is made of a metal film for connecting a top electrode 13, which is an element electrode of a MIM element, and the sintered wire 18 used as the scan line 19 is formed as a film (FIGS. 6(a) to 6(c)).

In the present invention, metal which constructs the sintered wire 18, or a metal film including this metal is used as a metal film for the sub-electrode 17. Specifically, the sintered wire 18 is made of low resistance metal such as Ag, Pd, Pt, or Au. Hence, the metal film for the sub-electrode 17 is made of these metals or a metal film including these metals. As an example of alloys of sub-electrode materials, metal which constructs the element electrode, for example, aluminum, or an aluminum alloy is desirable from a point of securing process consistency such as bondability with the element electrode, and processability.

In addition, when it is necessary to secure further thermal oxidation resistance for heat treatment in high temperature, and the like, metal which resists the thermal oxidation, for example, Ni, Cr, Mo, Ti, Ta, W, or Co, or an alloy including it is desirable. Furthermore, it was confirmed that improvement of electric connection characteristics was recognized so long as metal added to the sub-electrode 17 was more than 0.1 atomic weight % of metal which constructs the sintered wire 18.

Here, with paying attention to ease of wet processing, an Al—Ag alloy was used as a metal film for the sub-electrode 17. A film at 200 nm of film thickness was formed by the sputtering method using an Al—Ag alloy target. A ratio of Ag to Al was made to be 5 atomic weight %, for example. It is desirable that a film thickness of the sub-electrode 17 is a range of 100 to 1000 nm. An object of the sub-electrode 17 is to secure the connection characteristics between the sintered wire 18, used as the scan line 19, and the top electrode 13 which is a MIM element electrode, and hence, its own lower resistance is unnecessary.

In order to secure sticking property of the top electrode 13, in a region D (FIGS. 1(a) to 1(c)) which forms a junction with the top electrode 13, it is necessary to process a pattern edge of the sub-electrode 17 into a tapered shape. Since etching is performed isotropically in a pattern (horizontal) direction, and a film thickness (perpendicular) direction with making a photoresist edge a basis in usual wet etching, it is easy to secure the tapered shape, but unnecessarily thick filming is not desirable because a malfunction is generated in a processing shape.

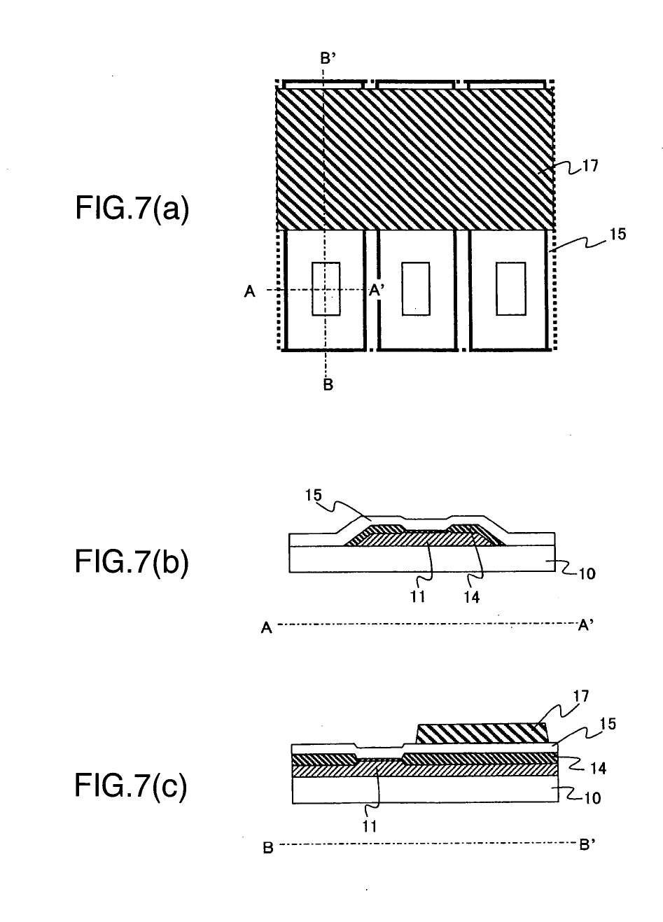

Next, by photoresist patterning and etching processes, the metal film for the sub-electrode 17 was processed into a stripe form so as to intersect the base electrode 11 through the protective insulating film 14 and inter-layer insulating film 15 (FIGS. 7(a) to 7(c)). For etching, for example, a mixed water solution of phosphoric acid, acetic acid, nitric acid is used. Although an electrode width changes with sizes and resolution of a display apparatus, it is made to be about 200 to 400 μm. Since this electrode has wide and simple stripe geometry, it is possible to pattern a resist by inexpensive proximity exposure, a printing method, or the like.

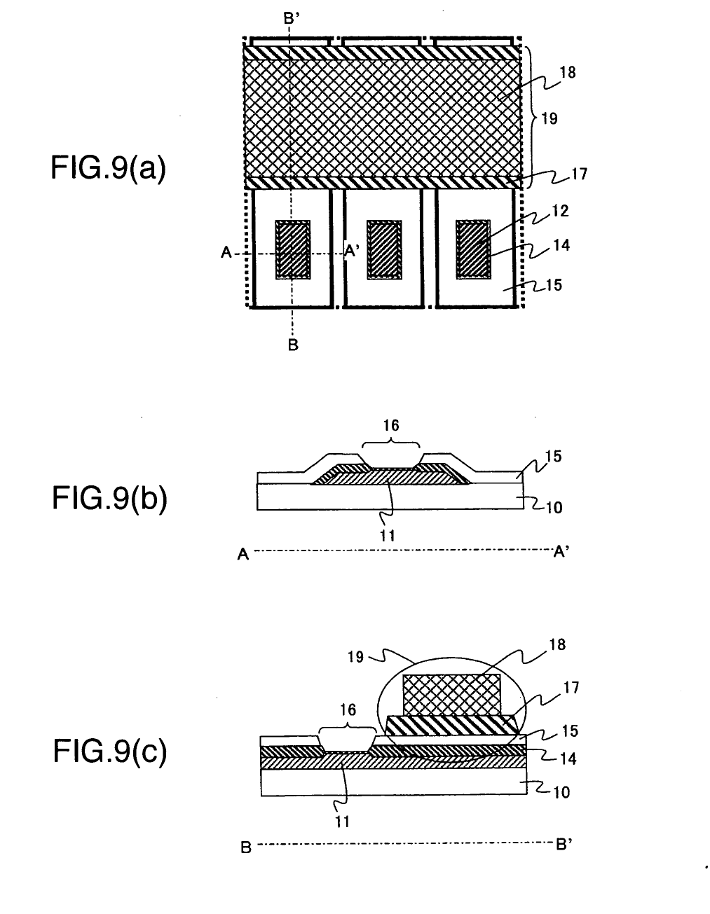

Next, a pattern of the sintered wire 18 which constructed the scan line 19 was formed on the pattern of the sub-electrode 17 (FIGS. 9(a) to 9(c)). Specifically, the sintered wire 18 was made of low resistance metal such as Ag, Pd, Pt, or Au. Here, the pattern of the sintered wire 18 was formed by the screen printing using Ag paste. Usually, a film thickness of the pattern of the sintered wire 18 is formed so as to become within a range of 5 to 30 nm. In addition, although a line width is usually formed so as to become within a range of 100 to 300 nm, in any case, it is a guidepost, and it is possible to adjust the film thickness and line width so as to obtain desired low resistance wire. For example, it is also possible to achieve lower resistance thick film by performing multiple times the screen printing.

In addition, here, although the pattern was formed by the screen printing using metal paste, it is also possible to form the pattern by the ink jet method using metal ink or the photo lithography method using photosensitive metal paste. Since it is possible to directly form an arbitrary low resistance thick film wire pattern by any method, it is advantageous also from an aspect of cost reduction. In addition, it is desirable also at a point that it is possible to form a pattern even using Pt and Au that processing by usual wet etching and dry etching is difficult.

After pattern formation, heat treatment for sintering the sintered wire 18 was performed. It is desirable to perform the heat treatment for sintering below or at heat-resistant temperature of an active device. Here, since the MIM cathode was provided as the active device, it was sintered at 400° C.

In the present invention, in this heat process, in a junction region C of the sub-electrode 17 and sintered wire 18, interdiffusion of metals which construct the sintered wire 18 arises between the sub-electrode 17 including the metal which constructs the sintered wire 18, and metal microparticles which become a base of the sintered wire 18. The interdiffused metals are promoted in melting and sticking, and grain growth in the interface, and junction the sintered wire 18 and sub-electrode 17 precisely. Thereby, with avoiding a problem of surface oxidization of the sub-electrode 17, it is possible to secure the electric connection between the sintered wire 18 and element electrodes, and to secure also sticking property of the sintered wire 18 itself formed on the sub-electrode 17.

Then, the inter-layer insulating film 15 was processed by photoresist patterning and etching, and the electron-emitting region 16 was opened (FIGS. 9(a) to 9(c)). The electron-emitting region 16 was formed in a part of a crossing section of one base electrode 11 in a pixel, and a space sandwiched by two scan lines 19 which intersects the base electrode 11. For example, dry etching which uses CF₄ and SF₆ as a main component can perform the etching.

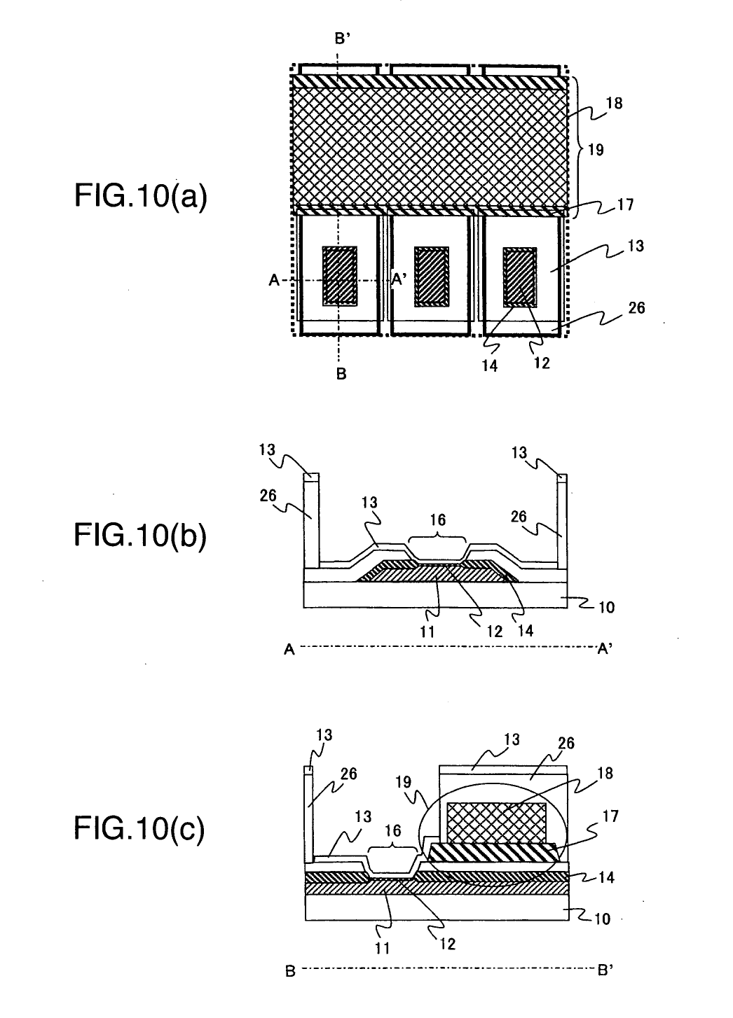

It is necessary that the top electrode 13 of the MIM element has structure of electrically separating from a scan line in the following stage which is connected to a pixel in the following stage. A lift off method was used for the separation of the top electrode 13 in this embodiment. First, a photoresist 26 for separation of the top electrode 13 was patterned on a portion except a junction of the electron-emitting region 16 and the sub-electrode 17 connected to the scan line 19 in its own stage, and then, the top electrode 13 was formed as a film (FIGS. 10(a) to 10(c)). As for a film forming method, for example, sputtering film formation is used. As the top electrode 13, for example, a stacked film of Ir, Pt, and Au was used, and a film thickness was made to be 6 nm.

Next, by removing the resist with the top electrode 13 formed as a film on the photoresist 26, the top electrode 13 was selectively formed only on the junction of the electron-emitting region 16 and sub-electrode 17 (FIGS. 1(a) to 1(c)). Thereby, the top electrode 13 was selectively connected to the scan line 19 in its own stage through the sub-electrode 17 (region D in FIGS. 1(a) to 1(c)), and it was possible to electrically separate from the scan line in the following stage.

By adopting the above-mentioned structure, it is possible to provide a display apparatus which can secure electric connection and sticking property with the top electrode 13, which is the MIM element electrode, even if the scan line 19 constructed of the sintered wire 18 being a thick film and easily having low resistance is used, and which is hardly influenced by a voltage drop with wire resistance.

Although the Ag wire was used as the sintered wire 18 and the Al—Ag alloy electrode was used as the sub-electrode 17 in this embodiment, the present invention is not limited to this, but it is possible to use a low resistance material such as Pd, Pt, or Au as the sintered wire 18, and to use metal with high thermal oxidation resistance, such as Cr, Al, W, Mo, Ni, or Co, or an alloy including it as parent metal of the sub-electrode 17. It is possible to process these metallic materials used as parent metal by wet etching by an adequately adjusting etchant composition.

Although the metal which constructed the sintered wire 18, or the metal film including this metal was used as the metal film for the sub-electrode 17 in this embodiment, it is possible to achieve an effect similar to the above by using a sub-layer, which includes at least the metal which constructs the sintered wire 18, in the connection interface C between the sintered wire 18 and sub-electrode 17.

Specifically, the sub-electrode 17 is constructed of layered structure of metals with different compositions, and a layer in a side of the sintered wire 18 equivalent to the connection interface C may be formed of the metal layer with the composition of the present invention. For example, achievement of lower resistance is performed by making second and upper layers compositions nearer to pure metal. Alternatively, it is also possible to perform an application of aiming at an improvement of an edge form by making second and upper layers compositions easier to be processed into a tapered shape, and the like. Also in that case, since the interface which contacts the sub-electrode 17 is constructs in the metal composition of the present invention in the connection region C, it is needless to say that it is possible to secure electric connection characteristics. In addition, it is also possible to form selectively a sub-layer, including the metal which constructs the sintered wire 18 from a topside of the sub-electrode 17 which constructs the connection interface C, by methods such as ion implantation and selective plating.

In addition, although the lift off method was used for separation of the top electrode in this embodiment, it is also possible to selectively form the top electrode film only in a required position using, for example, a mask at the time of top electrode film formation instead of the lift off method. Furthermore, for example, it is also sufficient to disconnect and separate the top electrode by ablation by selectively performing laser irradiation to the top electrode film formed in the whole surface only on a position to be separated.

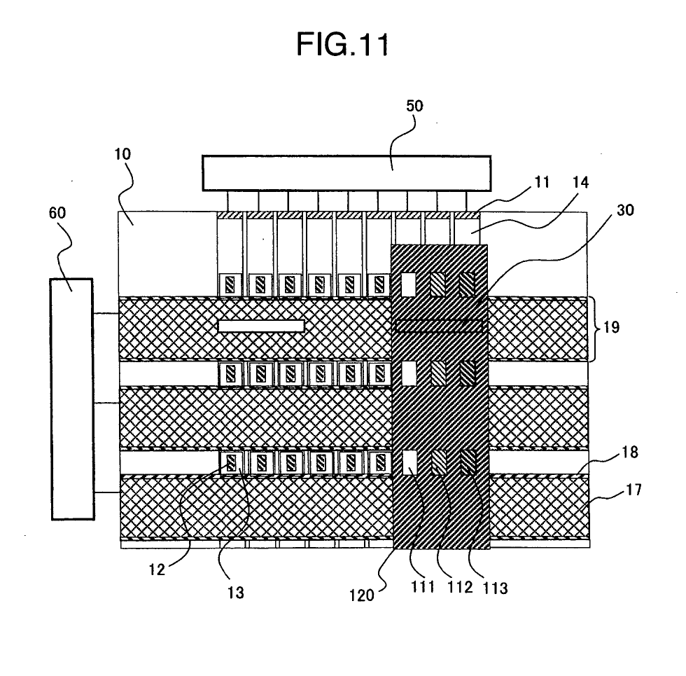

FIG. 11 shows a part of a display apparatus using the cathodes according to the present invention. A substrate in a display side has a black matrix 120 to increase contrast, red phosphor 111, green phosphor 112, and blue phosphor 113. As the phosphor, for example, Y₂O₂S:Eu (P22-R) is used for red, ZnS:Cu, Al (P22-G) is used for green, and ZnS:Ag, Cl (P22-B) is used for blue. The black matrix 120 is shown in a part of an image display region for the sake of drawing.

A spacer 30 is arranged on the scan line 19 of a cathode substrate, and it is arranged so that it may hide under the black matrix 120 of a phosphor screen substrate in a display side. The base electrode 11 is connected to a signal line drive circuit 50, and the scan line 19 is connected to a scan line drive circuit 60. In a thin-film electron-emitter array, since a voltage made to apply to a scan line is several V to tens of V, it is low enough to the fluorescence screen which applies several KV, and hence, it is possible to give potential almost near ground potential to a positive electrode side of the spacer 30.

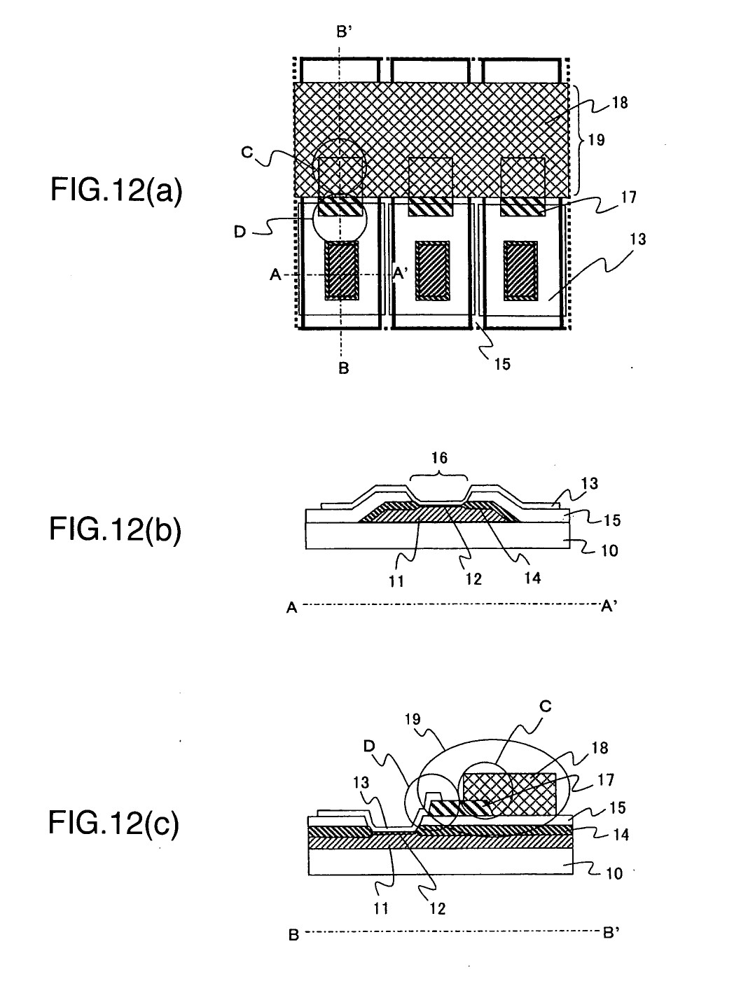

FIGS. 12(a), 12(b), and 12(c) show a second embodiment that the sub-electrode 17 formed in the stripe shape along with the sintered wire 18 in the first embodiment is selectively formed in the connection region C of the top electrode 13 and sintered wire 18. In FIGS. 12(a), 12(b), and 12(c), besides the top view of FIG. 12(a), FIG. 12(b) shows a sectional view taken on line A-A′ in the top view, and FIG. 12(c) shows a sectional view taken on line B-B′. By adopting such electrode pattern arrangement, even when a defect is generated in an individual MIM element connected through the sub-electrode 17, cut and modification in a portion of the sub-electrode 17 become easy. Also in this embodiment, the sub-electrode 17 is constructed of metal which constructs the sintered wire 18, or a metal film including this, and the similar effect is obtained as explained in the first embodiment.

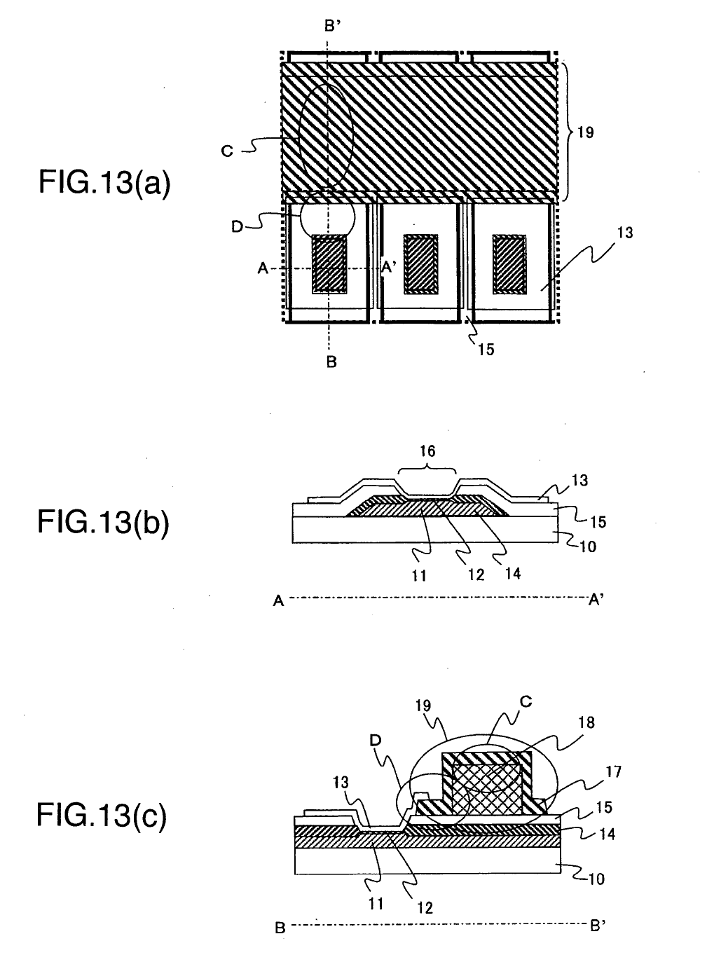

FIGS. 13(a), 13(b), and 13(c) show a third embodiment that the sub-electrode 17 is provided so as to coat and protect a surface and sides of a stripe pattern of the sintered wire 18 by replacing the layer order between the sintered wire 18 and sub-electrode 17 in the first embodiment. In FIGS. 13(a), 13(b), and 13(c), besides the top view of FIG. 13(a), FIG. 13(b) shows a sectional view taken on line A-A′ in the top view, and FIG. 13(c) shows a sectional view taken on line B-B′. Also in this embodiment, the sub-electrode 17 is constructed of metal which constructs the sintered wire 18, or a metal film including this, and the similar effect is obtained as explained in the first embodiment.

In the connection region C, also in the case that the layer order between the sub-electrode 17 and sintered wire 18 interchanges like this embodiment, interdiffusion of metals between the sub-electrode 17, including the metal which constructs the sintered wire 18, and the metal microparticles which become a base of the sintered wire 18 is generated without depending on the layer order between the sub-electrode 17 and sintered wire 18. Hence, it is possible to obtain the effect similar to that explained in the first embodiment.

In addition, in this embodiment, since the surface and sides of the sintered wire 18 are completely coated with the material of the sub-electrode 17, it is possible in subsequent processes to protect the sintered wire 18 from disconnection or corrosion, and hence, it is possible to improve a yield of the scan line 19.

The first, second, and third embodiments show the embodiments of using the sub-electrode 17 for connection between the sintered wire 18, which construct the scan line 19, and the top electrode 13 in the interconnection structure that the scan line 19 becomes an upper layer to the base electrode 11 used as a signal line. In such structure, since it became the structure of performing heat treatment for sintering the sintered wire 18 after providing an MIM cathode, there was a restriction of having to perform sintering below or at heat-resistant temperature of the MIM element.

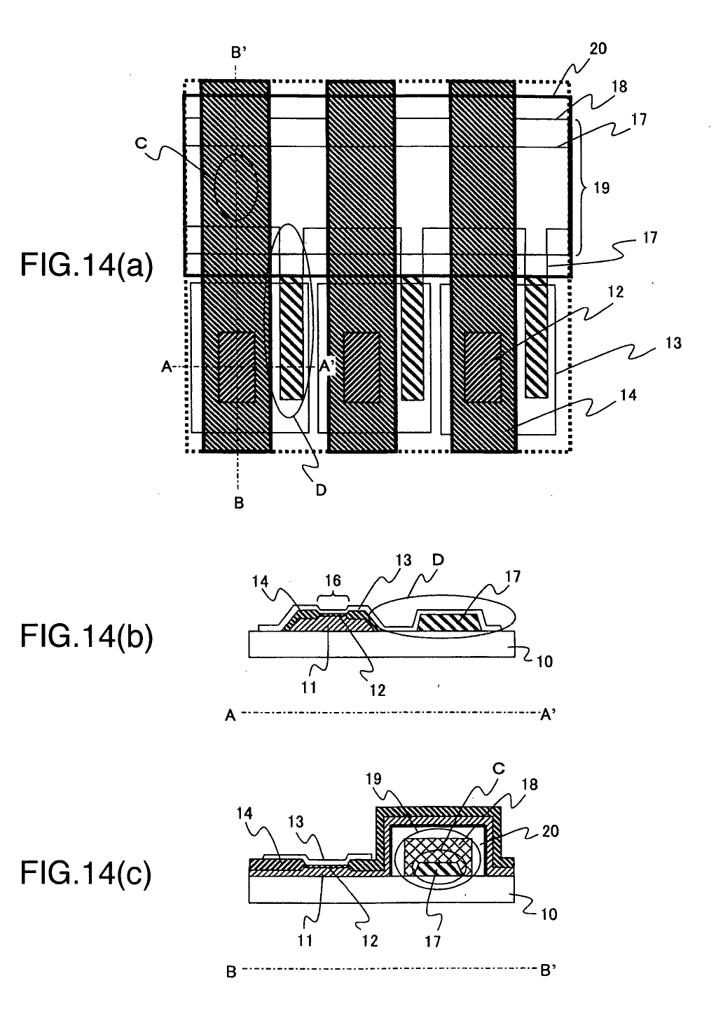

FIGS. 14(a) to 20(c) show a fourth embodiment of making it possible to perform heat treatment for sintering independently of the restriction of the heat-resistant temperature of the MIM element by replacing the layer order between the base electrode 11, used as a signal line, and the scan line 19. In FIGS. 14(a) to 20(c), besides the top views of Figs. xx(a), Figs. xx(b) show sectional views taken on line A-A′ in the top views, and Figs. xx(c) show sectional views taken on line B-B′.

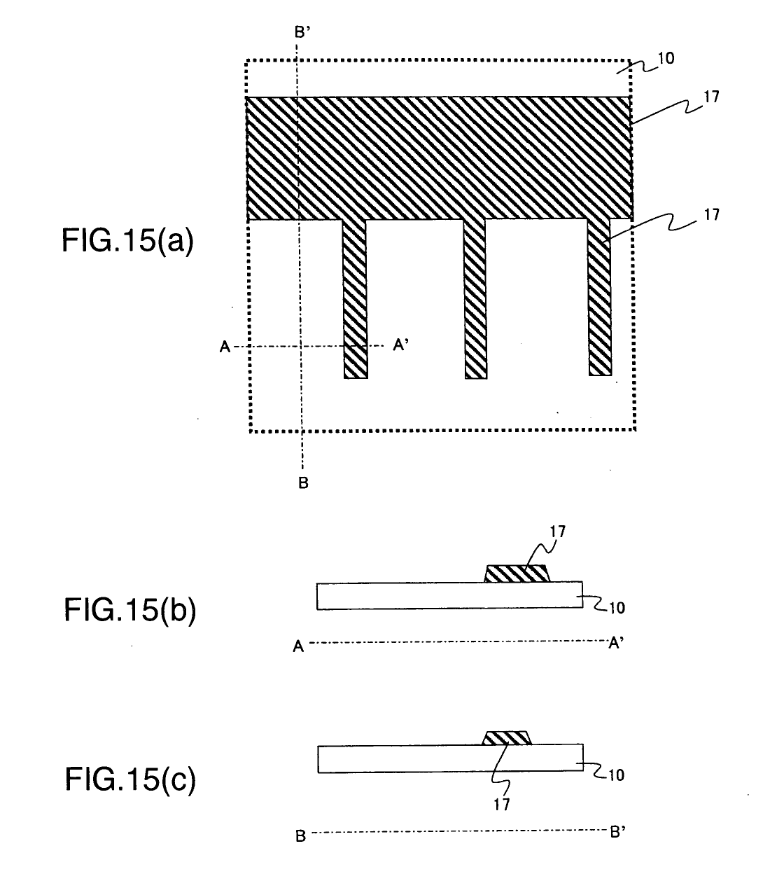

First, a pattern of the sub-electrode 17 was formed on the insulative substrate 10 such as glass (FIGS. 15(a) to 15(c)). Naturally, the sub-electrode 17 was constructed of metal which constructed the sintered wire 18, or a metal film including this.

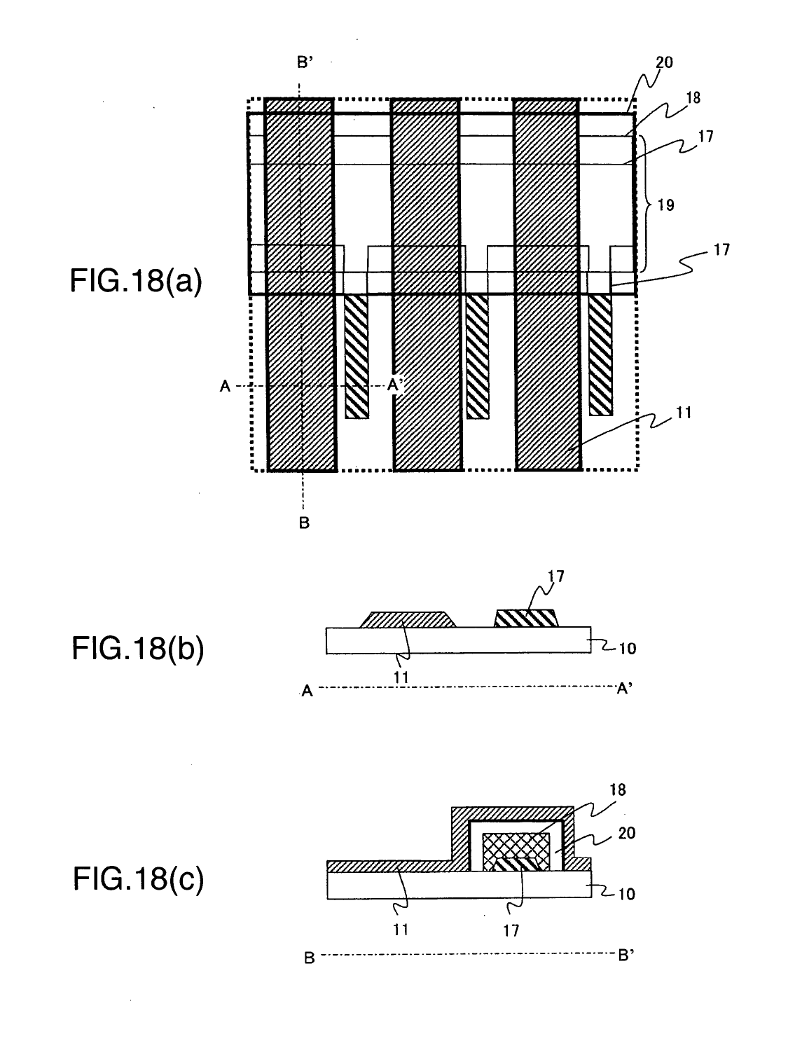

A different point from the first embodiment is a point that it becomes necessary to process selectively a signal line, which serves as the base electrode 11 which is an element electrode of a MIM, on the pattern of the sub-electrode 17 in a process mentioned later in FIGS. 18(a) to 18(c). Hence, it is necessary to avoid an Al alloy, which is a constituent material of the base electrode 11, as parent metal of the sub-electrode 17.

Here, with paying attention to ease of selective processing by wet etching, Cr was used as a metal film for the sub-electrode 17. A film at 100 nm of film thickness was formed by the sputtering method using a Cr target including Au. A ratio of Au to Cr was made to be 0.1 atomic weight %, for example. By photoresist patterning and etching processes, the metal film for the sub-electrode 17 was processed into a stripe form so as to intersect the base electrode 11 through an inter-layer insulating film 20. For example, an aqueous solution of diammonium cerium(IV) nitrate was used for etching (FIGS. 15(a) to 15(c)).

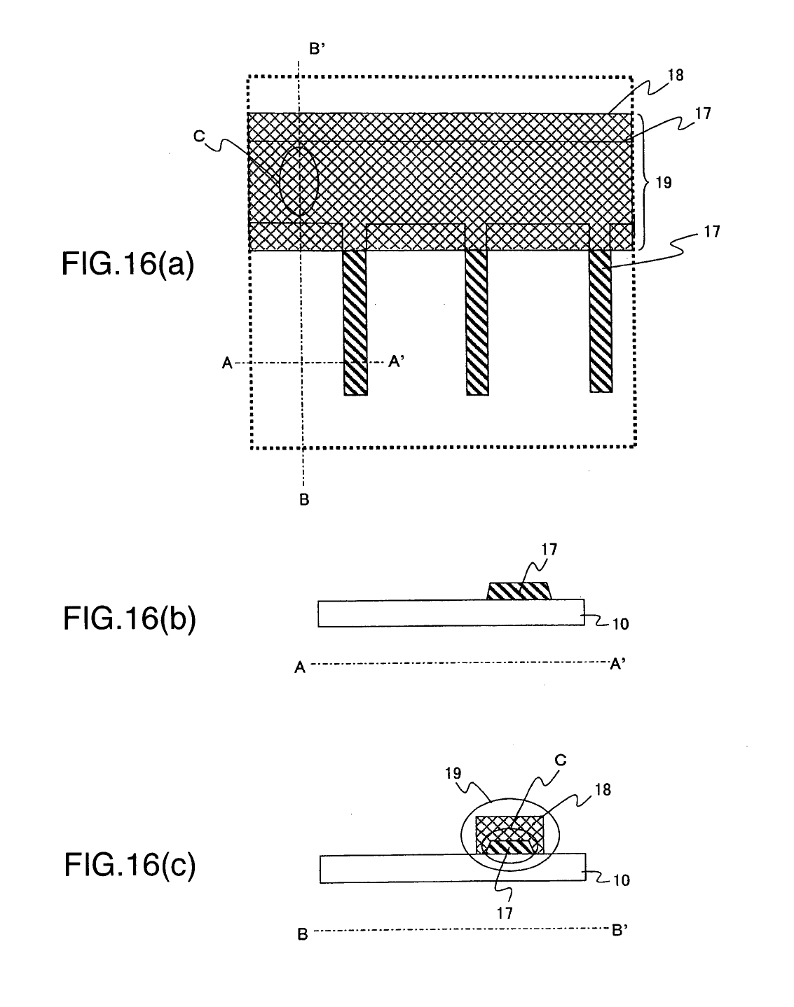

Next, with avoiding the connection-scheduled portion D between the sub-electrode 17 and top electrode 13 which were formed previously (FIGS. 14(a) to 14(c)), a pattern of the sintered wire 18 which constructed the scan line 19 was formed on the pattern of the sub-electrode 17 by the screen printing using Ag paste including Au (FIGS. 16(a) to 16(c)). A film thickness of the sintered wire pattern 18 was made to be 10 nm.

Although the pattern of the sintered wire 18 was formed by single printing in this embodiment, for example, it is also possible to achieve lower resistance thick film by performing multiple times the screen printing. In addition, it is also possible to achieve further lower resistance by making the sintered wire 18 into layered structure of metals with different compositions, and making second and upper layers into compositions nearer to pure metal. Also in that case, it is needless to say that it is possible to secure good electric connection characteristics in the interface, which contacts the sub-electrode 17, in the connection region C.

After pattern formation, although heat treatment for sintering the sintered wire 18 is performed, since it is before providing an MIM element, which is an active device, in this embodiment, sintering in high temperature beyond or at the heat-resistant temperature of the MIM element is possible. Here, the sintering was performed at 550° C. at which sintering of the sintered wire 18 could be promoted and the achievement of lower resistance of wire became easy.

Also in this embodiment, in the connection region C between the sub-electrode 17 and sintered wiring 18 which constructs the scan line 19, interdiffusion of metals between the sub-electrode 17, including the metal which constructs the sintered wiring 18, and the metal microparticles which become a base of the sintered wiring 18 is generated during this heat treatment process. Hence, as explained in the first embodiment, it is possible to obtain satisfactory electric connection between the sub-electrode 17 and sintered wiring 18.

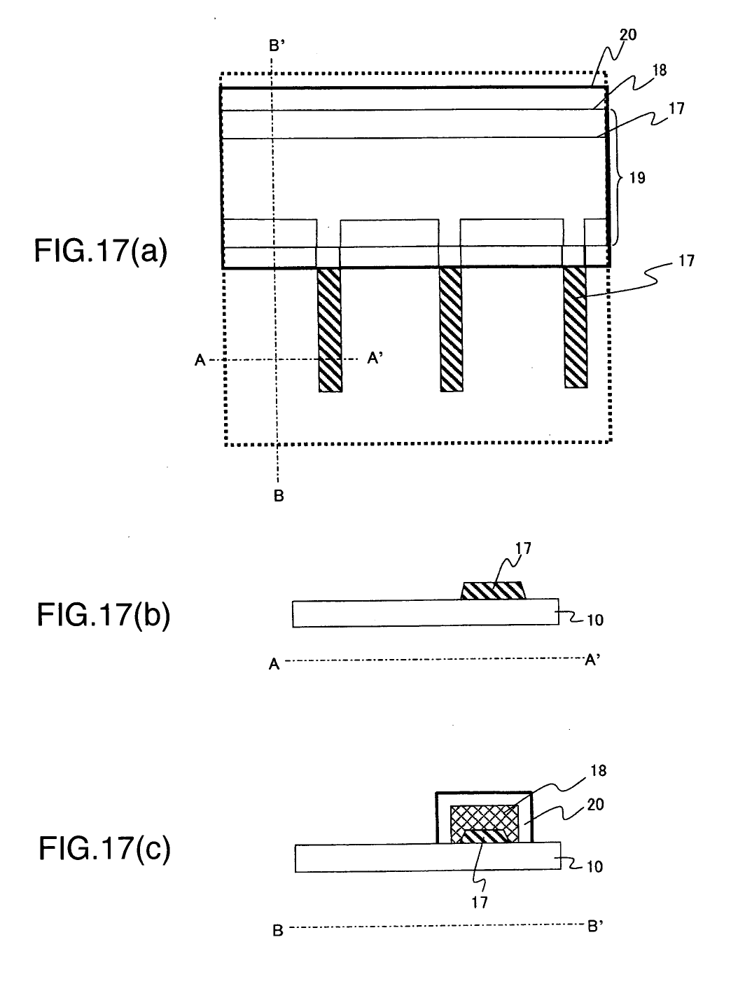

Then, a pattern of the inter-layer insulating film 20 which performed interlayer separation of the base electrode 11, used as a signal line, and the scan line 19, which intersected it, was formed (FIGS. 17(a) to 17(c)). Here, dielectric glass paste was used as the inter-layer insulating film 20. With avoiding the connection-scheduled portion D between the sub-electrode 17 and top electrode 13 which were formed previously (FIGS. 14(a) to 14(c)), the dielectric glass paste was selectively formed by the screen printing so as to coat the sintered wiring 18, and sintering was performed at 550° C.

As the pattern of the inter-layer insulating film 20, after a forming silicon oxide film, a silicon nitride film, a silicon film, or the like similarly to the first embodiment instead of the dielectrics glass paste, it is sufficient to remove an unnecessary part selectively by photoresist patterning and etching, and to form it.

Next, a pattern of the base electrode 11 which was an element electrode of the MIM element was formed in a stripe form so as to intersect the scan line 19, and it was made to serve also as a signal line as it is (FIGS. 18(a) to 18(c)). Here, after forming a film with 300 nm of film thickness by the sputtering method using as a target an Al—Nd alloy in which 2 atomic weight % of Nd was doped, the film was processed into a stripe form by a photoresist patterning process and an etching process as the pattern of the base electrode 11. As mentioned above, although it is necessary to perform selective processing to the sub-electrode 17 formed previously, it is possible to selectively process only the pattern of the base electrode 11 without damaging the pattern of the sub-electrode 17 whose parent material is Cr by performing etching using, for example, a mixed water solution of phosphoric acid, acetic acid, or nitric acid.

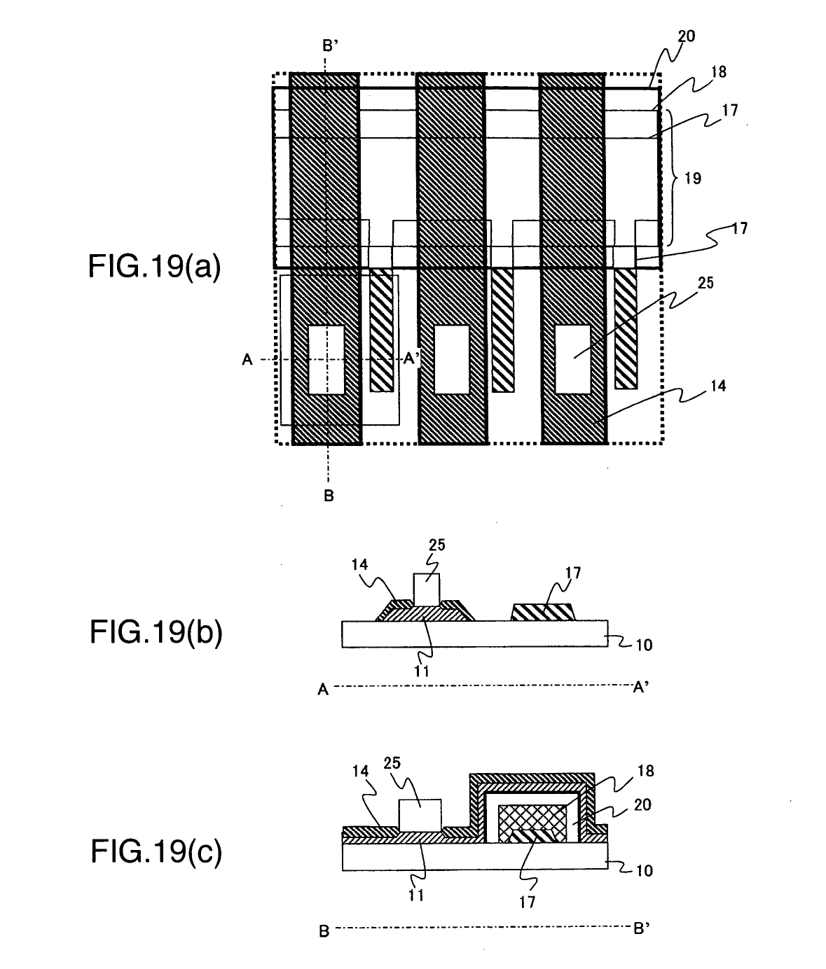

Next, a protective insulation layer 14 which limited an electron-emitting region 16 and prevented electric field concentration to edges of the base electrode 11 of an element was formed. A portion used as an electron-emitting region on the base electrode 11 was masked with the resist film 25, and another portion was selectively anodized, which was made the protective insulation layer 14 at a film thickness of 200 nm (FIGS. 19(a) to 19(c)).

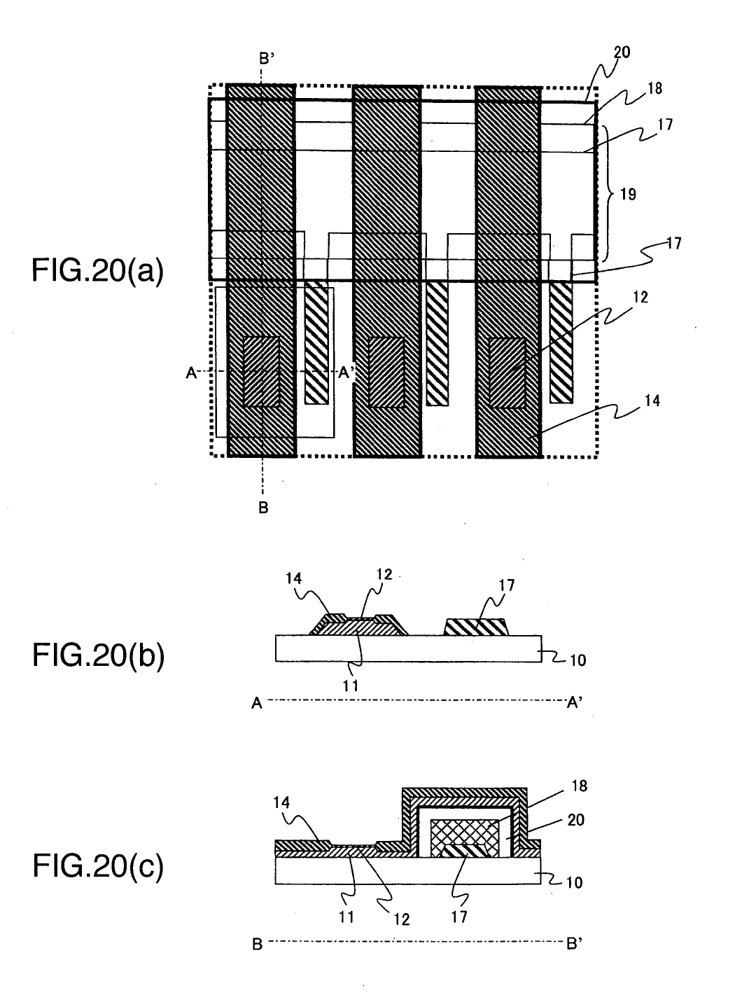

Subsequently, the resist film 25 was removed and a surface of the remaining base electrode 11 was anodized, and the insulator 12 which was an electronic acceleration layer about 10 nm thick was formed on the base electrode 11 (FIGS. 20(a) to 20(c)).

Finally, using the lift off method, a pattern of the top electrode 13 of the MIM element is selectively formed only in the region D which is a junction between the electron-emitting region 16 and sub-electrode 17 (FIGS. 14(a) to 14(c)). As the top electrode 13, for example, a stacked film of Ir, Pt, and Au was used, and a film thickness was made to be 6 nm.

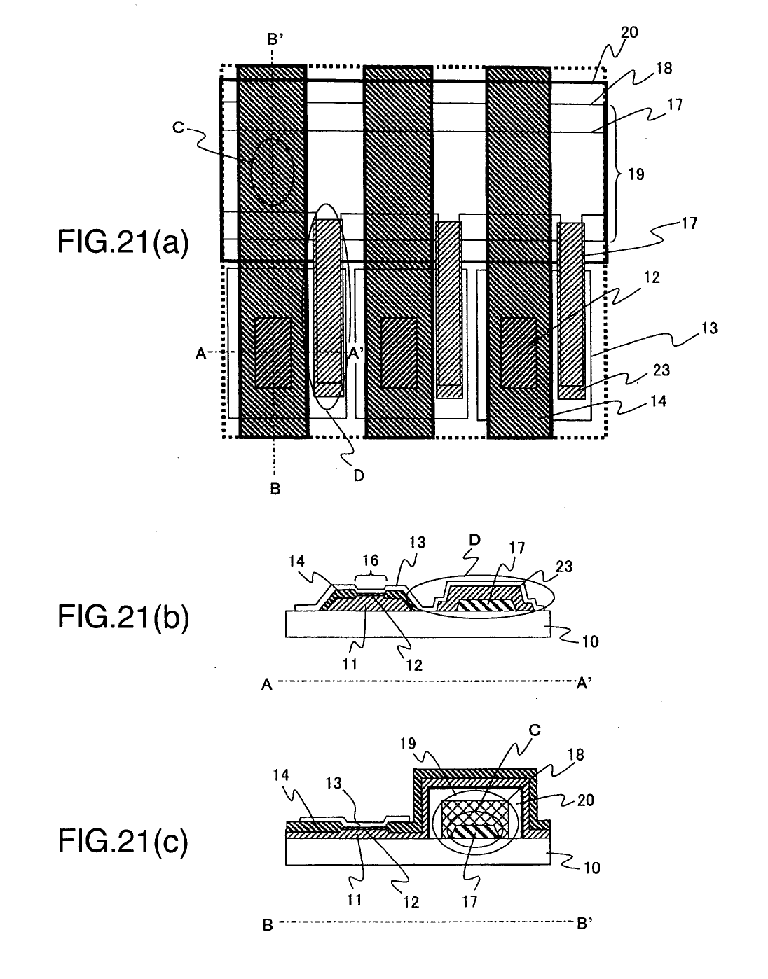

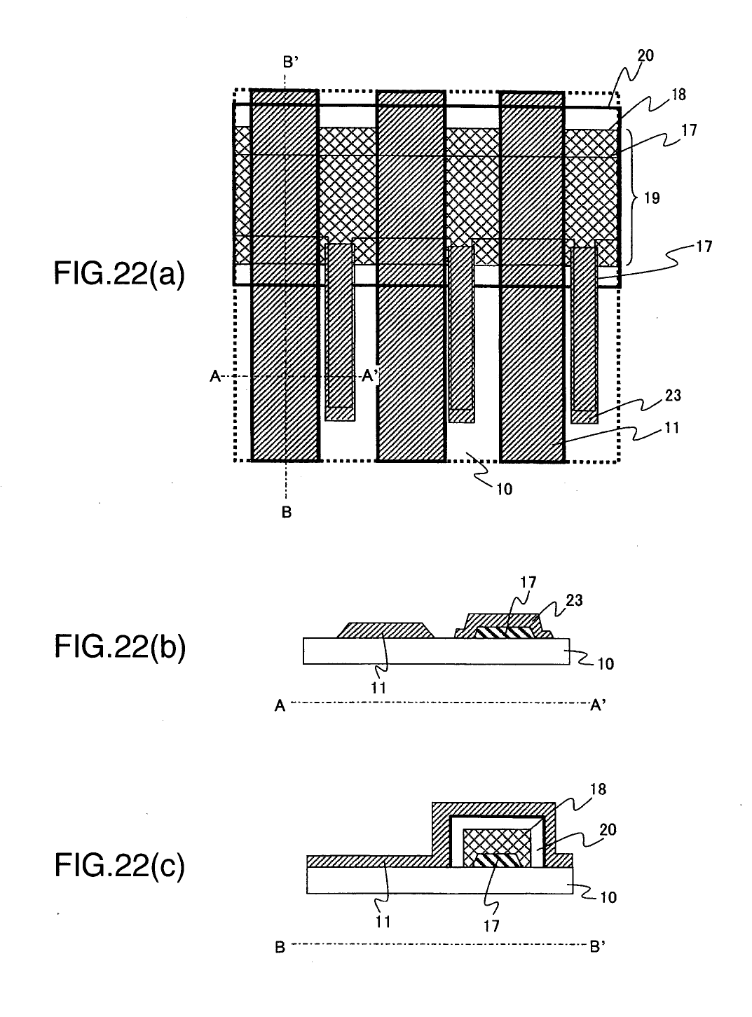

FIGS. 21(a) to 22(c) show a fifth embodiment that a protection electrode 23 is provided so as to coat the junction D of the sub-electrode 17 in the fourth embodiment. In FIGS. 21(a) to 22(c), besides the top views of Figs. xx(a), Figs. xx(b) show sectional views taken on line A-A′ in the top views, and Figs. xx(c) show sectional views taken on line B-B′.

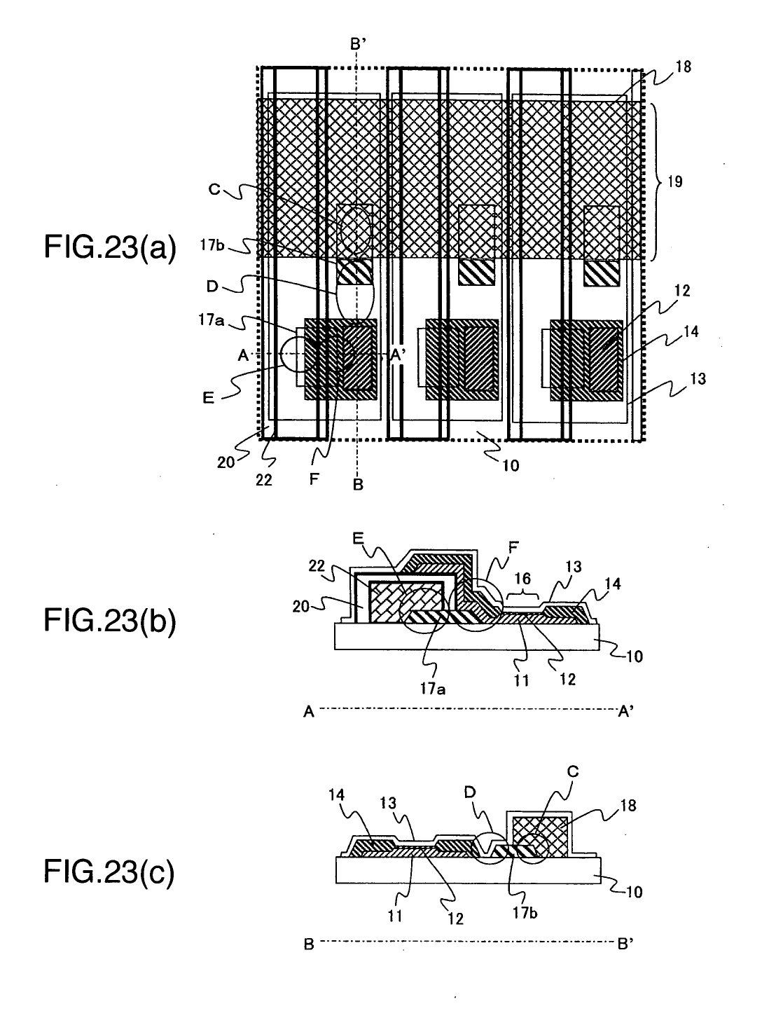

A different point from the fourth embodiment is a point that the protection electrode 23 which is made of the same constituent material as the pattern of the base electrode 11 was formed also in the region D which forms the junction with the top electrode 13 so as to coat pattern exposure portions of the sub-electrode 17, at the same time of pattern formation of the base electrode 11 in a forming process of the base electrode 11 used also as a signal line, as shown in FIGS. 18(a) to 18(c) of the fourth embodiment (FIGS. 23(a) to 23(c)).

By adopting such structure, selective processing of the sub-electrode 17 and base electrode 11 which was an indispensable matter in the fourth embodiment becomes unnecessary. Thereby, it becomes possible also to use Al as an alloy parent material of the sub-electrode 17. For example, it is possible to use combination of Ag wire used as the sintered wiring 18 used in the first embodiment, and an Al—Ag alloy electrode used as the sub-electrode 17.

The first to fifth embodiments show embodiments of using the sub-electrode 17 for connection of the sintered wiring 18, which constructs the scan line 19, and the top electrode 13. FIGS. 23(a) to 30(c) show a sixth embodiment in which sintered wiring is applied to a signal line 22 and the scan line 19. In FIGS. 23(a) to 30(c), besides the top views of Figs. xx(a), Figs. xx(b) show sectional views taken on line A-A′ in the top views, and Figs. xx(c) show sectional views taken on line B-B′.

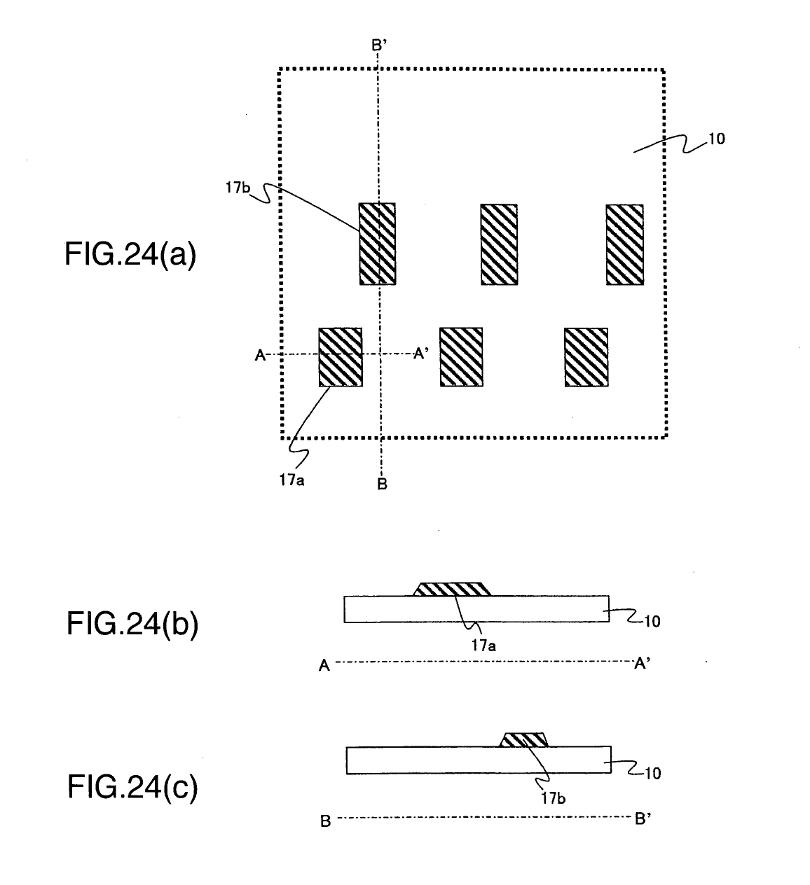

First, on the insulative substrate 10 such as glass, a pattern of a sub-electrode 17a for connecting the base electrode 11 and signal line 22, and a sub-electrode pattern 17b for connecting the top electrode 13 and the sintered wiring 18 used as the scan line 19 were formed respectively (FIGS. 24(a) to 24(c)). Naturally, the sub-electrodes 17a and 17b were constructed of metal which constructed the sintered wiring 18 and signal line 22, or metal films including this. For example, they are formed using Cr electrodes which including Au used in the Embodiment 4.

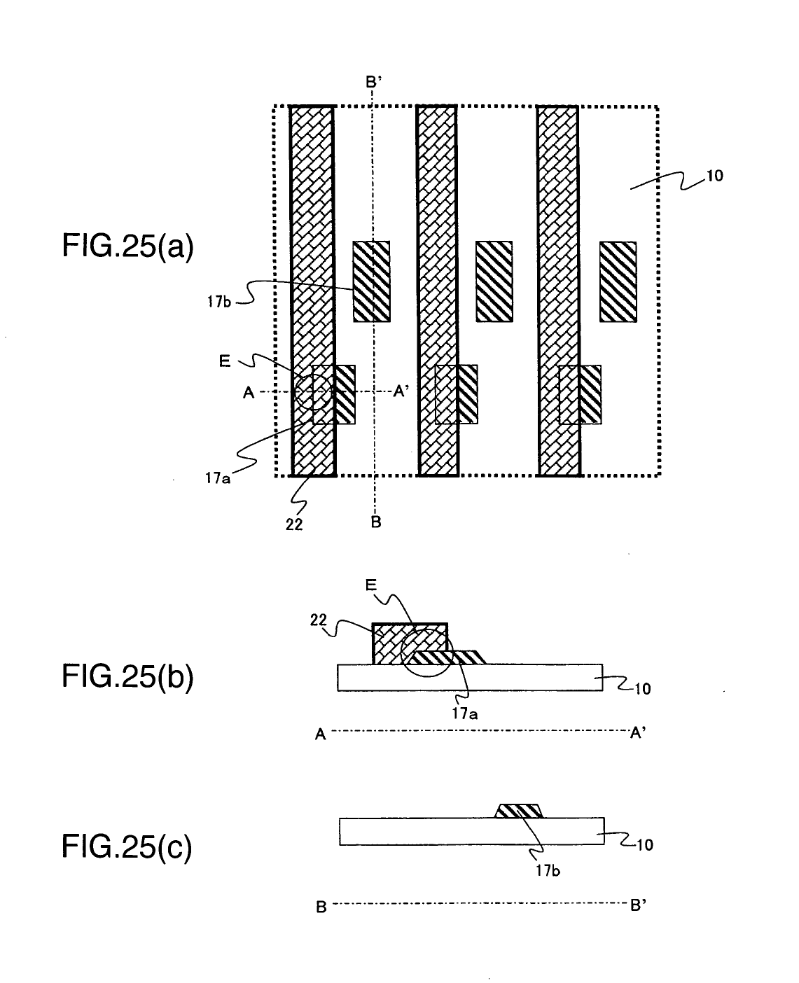

Next, on the pattern of the sub-electrode 17a, the signal line 22 used as sintered wiring was formed so as to partially superimpose the pattern of the sub-electrode 17a (FIGS. 25(a) to 25(c)). This superposing portion became a connection region E of the sub-electrode 17a and signal line 22 used as sintered wiring. For example, by the screen printing using Ag paste including Au, 5 nm of signal line 22 used as sintered wiring was formed, and, subsequently heat treatment for sintering was performed.

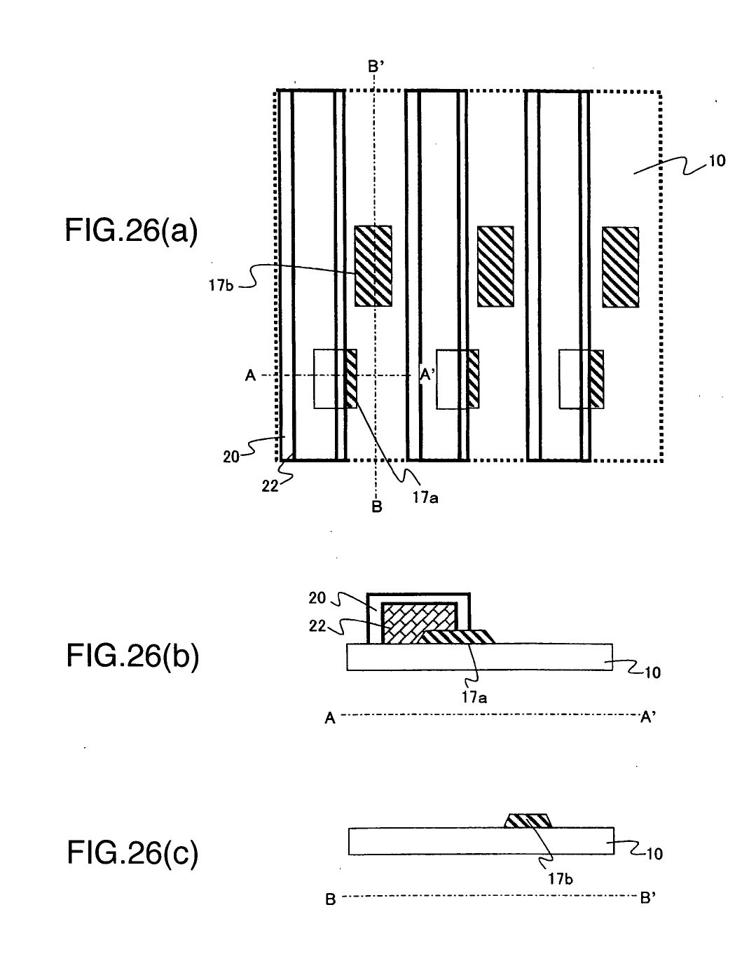

Then, a pattern of the inter-layer insulating film 20 which performed interlayer separation of the scan line 19 and the signal line 22 was formed (FIGS. 26(a) to 26(c)). With avoiding a connection-scheduled portion between the sub-electrode 17a, which had been formed previously, and the base electrode 11 which will be mentioned later, a pattern of the interlayer insulating film 20 which was made of dielectric glass paste was selectively formed by the screen printing so as to coat the signal line 22, and sintering was performed at 550° C.

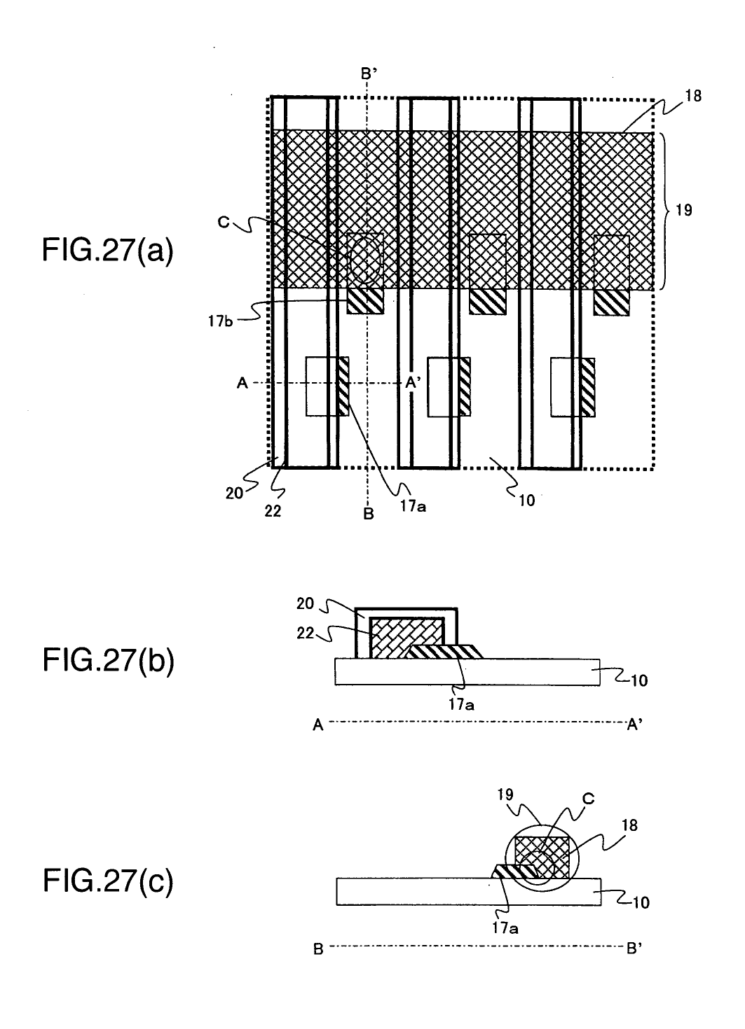

Next, on the pattern of the sub-electrode 17b, the sintered wiring 18 used as the scan line 19 was formed so as to partially superimpose the pattern of the sub-electrode 17b (FIGS. 27(a) to 27(c)). This superposing portion became the connection region C of the sub-electrode 17b and sintered wiring 18. For example, by the screen printing using Ag paste including Au, 10 nm of sintered wiring 18 was formed, and, subsequently heat treatment for sintering was performed.

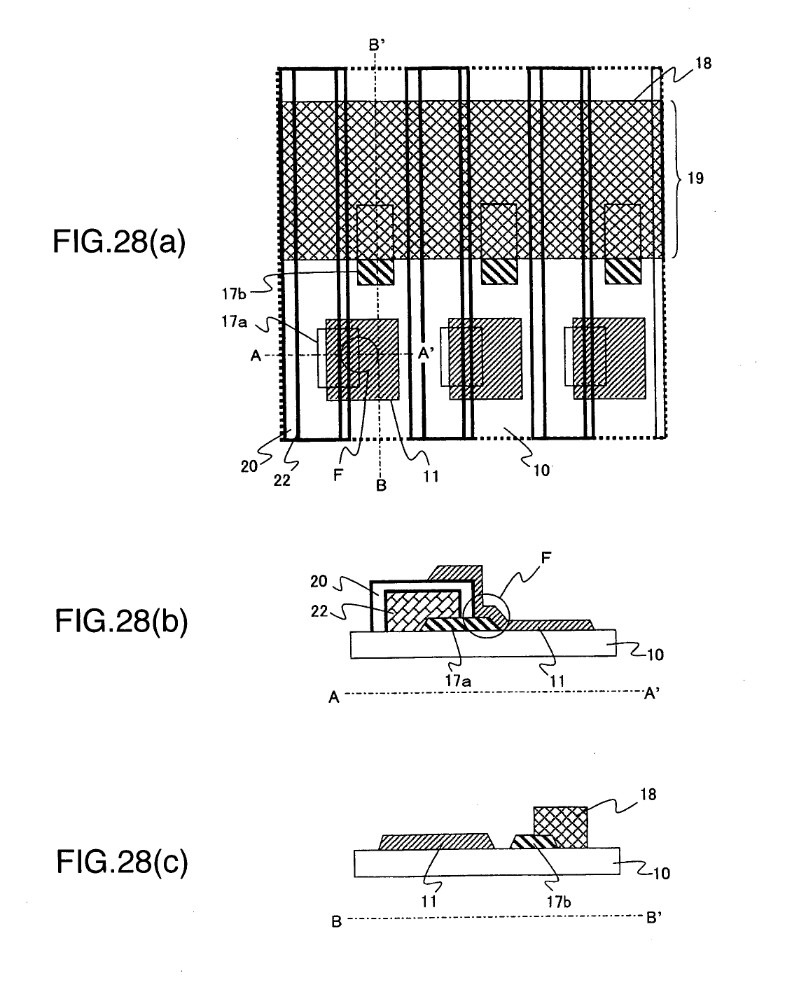

Next, the pattern of the base electrode 11 which was an element electrode of the MIM element was fully coated so that there might be no surface exposure of the sub-electrode 17a, and a connection region F was formed (FIGS. 28(a) to 28(c)). Here, after forming a film with 300 nm of film thickness by the sputtering method using as a target an Al—Nd alloy in which 2 atomic weight % of Nd was doped, the film was processed into a stripe form by a photoresist patterning process and an etching process as the pattern of the base electrode 11. As mentioned in the fourth embodiment, although it is necessary to perform selective processing to the exposed portion of the sub-electrode 17b formed previously, it is possible to selectively process only the pattern of the base electrode 11 without damaging the pattern of the sub-electrode 17b whose parent material is Cr by performing etching using, for example, a mixed water solution of phosphoric acid, acetic acid, or nitric acid.

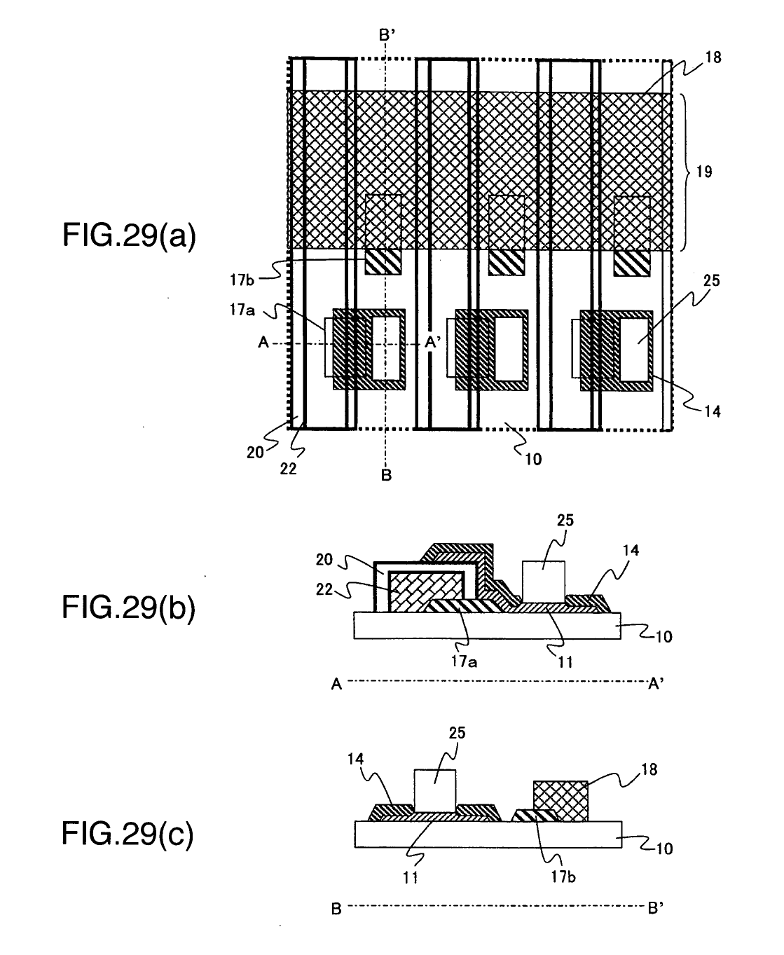

Then, the protective insulation layer 14 which limits an electron-emitting region and prevents electric field concentration to edges of the base electrode 11 was formed. A portion used as an electron-emitting region on the base electrode 11 was masked with the resist film 25, and another portion was selectively anodized, which was made the protective insulation layer 14 at a film thickness of 200 nm (FIGS. 29(a) to 29(c)).

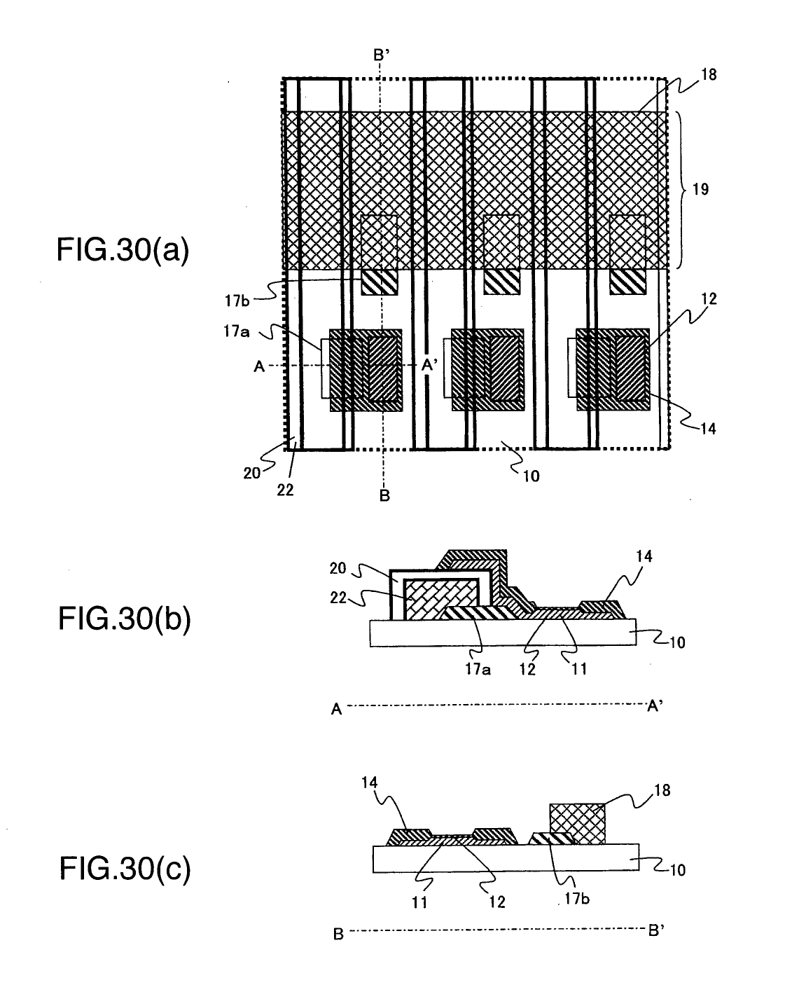

Subsequently, the resist film 25 was removed and a surface of the remaining base electrode 11 was anodized, and the insulator 12 which was an electronic acceleration layer about 10 nm thick was formed on the base electrode 11 (FIGS. 30(a) to 30(c)).

Finally, using the lift off method, a pattern of the top electrode 13 of the MIM element was selectively formed in a region including the electron-emitting region 16, and the region D which was a junction between the base electrode 11 and sub-electrode 17b (FIGS. 23(a) to 23(c)). As the top electrode 13, for example, a stacked film of Ir, Pt, and Au was used, and a film thickness was made to be 6 nm.

Also in this embodiment, it is necessary to secure electric connection between the signal line 22, which is made of sintered wiring, and the sub-electrode 17a in the connection region E, and electric connection between the sintered wiring 18, used as a scan line, and the sub-electrode 17b in the connection region C, respectively. Hence, the sub-electrodes 17a and 17b are constructed of metal which constructs the signal line 22 and sintered wiring 18, which are connection partners, or metal films including this. Hence, the interdiffusion which constructs sintered wiring is generated between the sub-electrodes 17a and 17b, and the metal microparticles, which become a base of the sintered wiring, during a process of heat treatment for sintering. Hence, since melting and sticking, and grain growth of the interdiffused metals are promoted in the interface, it is possible to junction the signal line 22 which is the sintered wiring, and the sub-electrode 17a, and the sintered wiring 18 and sub-electrode 17b precisely. Thereby, with avoiding a problem of surface oxidization of the sub-electrodes 17a and 17b, it is possible to secure the electric connection between the sintered wire and element electrode.

The signal line 22, which is made of sintered wiring, and the base electrode 11 of the MIM element are connected through the sub-electrode 17a in this embodiment. But, also by using the metal which constructs sintered wiring or a metal film including this metal as the base electrode 11 and directly connecting the signal line 22 which is made of the sintered wiring, and the base electrode 11, it is possible to achieve the effect similar to the above.

On the other hand, the sub-electrode 17a is necessary to secure connection characteristics between the signal line 22 and base electrode 11 in the connection region F, and the sub-electrode 17b is necessary to secure connection characteristics between the sintered wiring 18 and top electrode 13 in the connection region D, respectively. Specifically, in order to secure sticking property of the base electrode 11 and top electrode 13, it is necessary to process pattern edges of the sub-electrodes 17a and 17b into tapered shapes. Since the pattern edges of the sub-electrodes 17a and 17b are formed through photoresist patterning and wet etching processes, it becomes easy to secure forward tapered shapes. Hence, it is needless to say that it is possible to secure satisfactory connection characteristics in a sufficient yield in comparison with the case of direct connection of the signal wiring 22 and base electrode 11, and the sintered wiring 18 and top electrode 13.

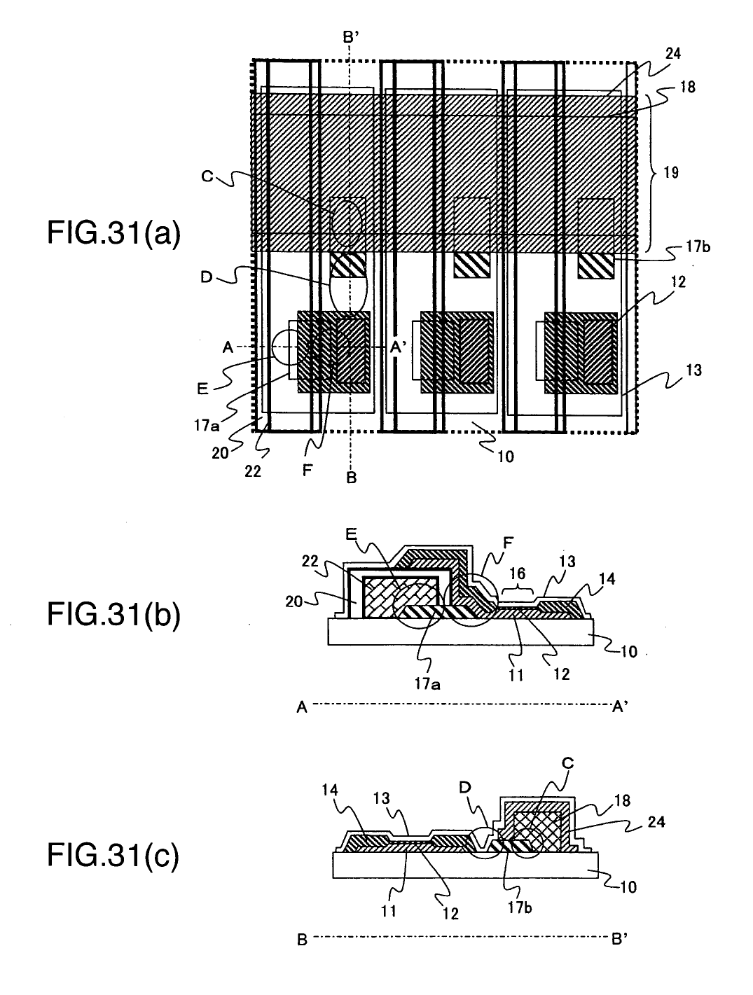

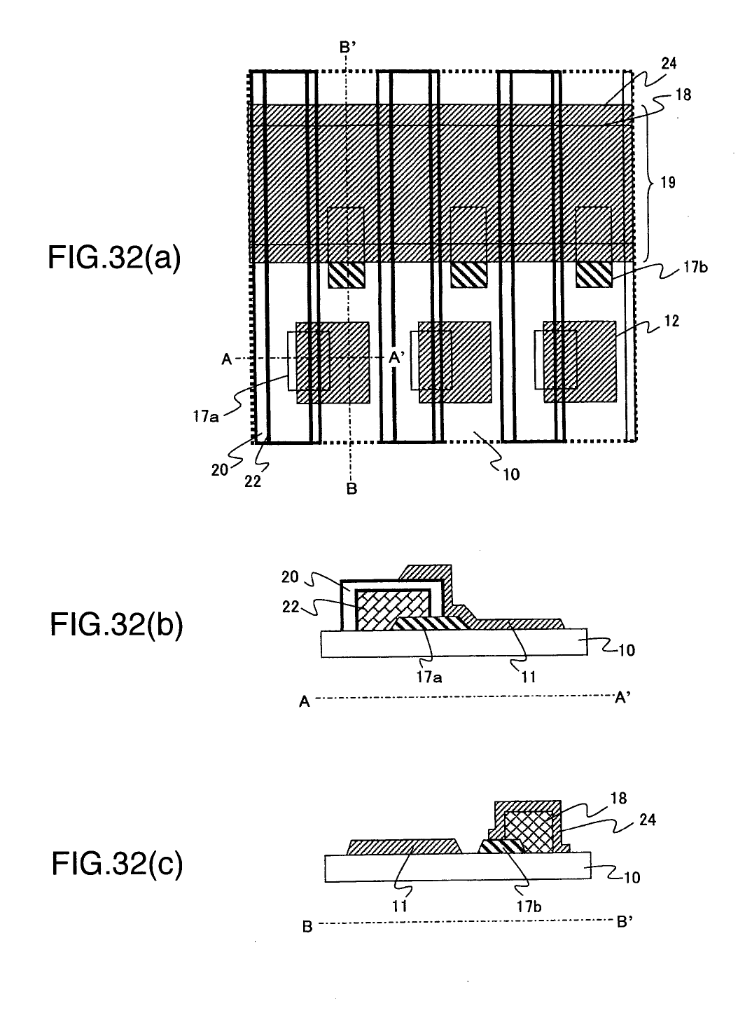

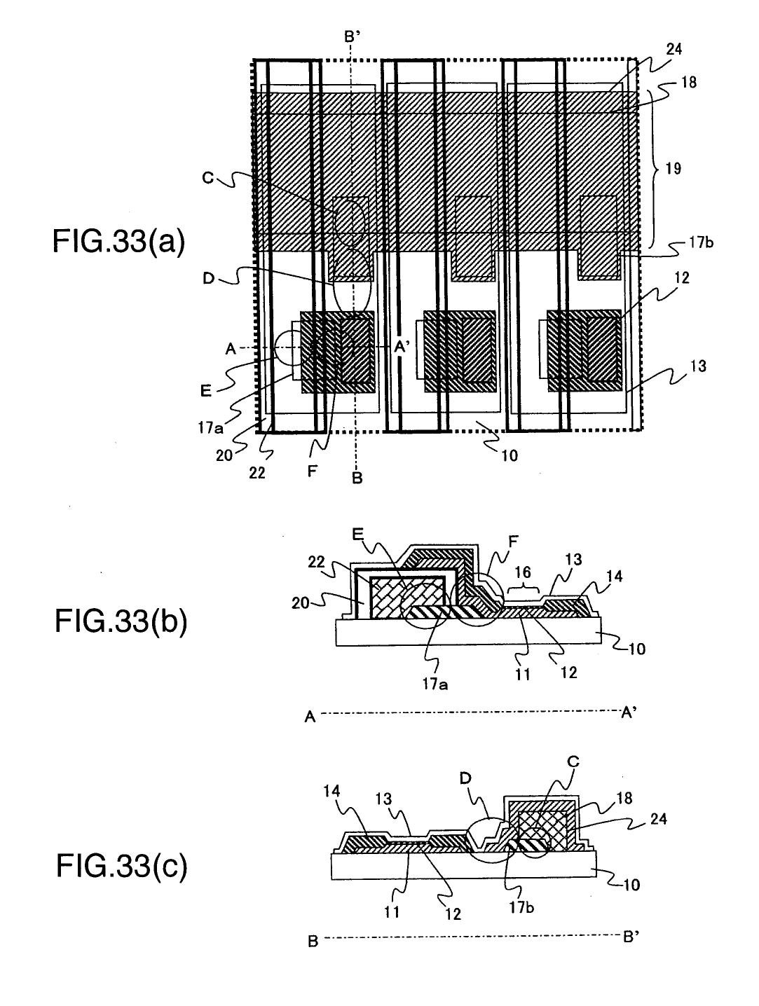

FIGS. 31(a) to 32(c) show a seventh embodiment that the protection electrode 24 is formed so as to coat and protect a surface and sides of a stripe pattern of the sintered wiring 18, which constructs the scan line 19, in the sixth embodiment. In FIGS. 32(a) to 33(c), besides the top views of Figs. xx(a), Figs. xx(b) show sectional views taken on line A-A′ in the top views, and Figs. xx(c) show sectional views taken on line B-B′.

A different point from the sixth embodiment is a point that the protection electrode 24 which was made of the same constituent material as the pattern of the base electrode 11 was formed so as to coat exposure portions of the sintered wiring 18, at the same time of pattern formation of the base electrode 11 in a forming process of the base electrode 11, as shown in FIGS. 28(a) to 28(c) of the sixth embodiment (FIGS. 32(a) to 32(c)).

In this embodiment, since the surface and sides of the sintered wiring 18 are fully coated with the protection electrode 24, it is possible in subsequent processes to protect the sintered wiring 18 from disconnection or corrosion, and hence, it is possible to improve a yield of the scan line 19.

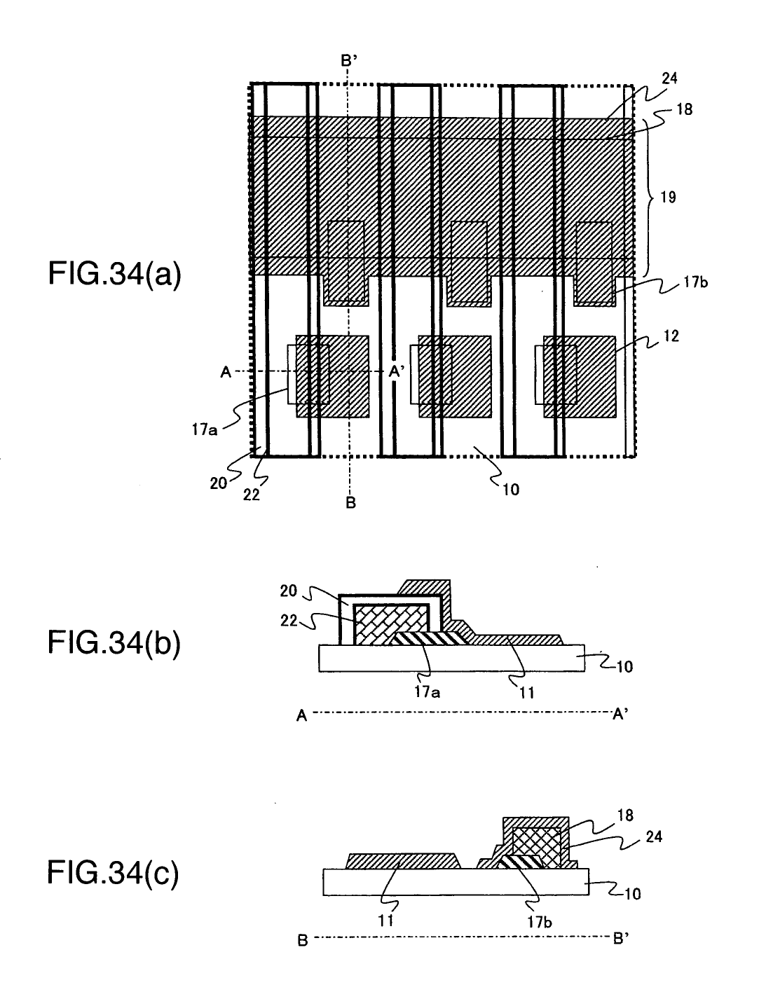

FIGS. 33(a) to 34(c) show an eighth embodiment that the protection electrode 24 is provided so as to coat not only the sintered wiring 18, which constructs the scan line 19, but also pattern exposure portions of the sub-electrode 17b in the seventh embodiment. In FIGS. 33(a) to 34(c), besides the top views of Figs. xx(a), Figs. xx(b) show sectional views taken on line A-A′ in the top views, and Figs. xx(c) show sectional views taken on line B-B′.

A different point from the seventh embodiment is a point that the protection electrode 24 which was made of the same constituent material as the pattern of the base electrode 11 was formed also the region D which forms the junction with the top electrode 13 so as to coat the whole pattern of the sub-electrode 17b and not to expose it, at the same time of pattern formation of the base electrode 11 in a forming process of the base electrode 11, as shown in FIGS. 32(a) to 32(c) of the seventh embodiment (FIGS. 34(a) to 34(c)).

By adopting such structure, selective processing of the sub-electrode 17b and base electrode 11 which was an indispensable matter in the seventh embodiment becomes unnecessary. Thereby, it becomes possible also to use Al as an alloy parent material of the sub-electrode 17b. For example, it is possible to use combination of Ag wire used as the sintered wiring 18 used in the first embodiment, and an Al—Ag alloy electrode used as the sub-electrode 17b.

Although the MIM cathode is explained as an example in a series of above-mentioned embodiments, the present invention is not limited to an MIM cathode. Since the achievement of lower resistance of wiring is a task common to FEDs, the cathode with the electrode wiring structure of the present invention is similarly applicable also to a Spindt type cathode, a surface conduction cathode, a carbon nanotube type cathode, and thin film cathodes such as an MIS type one, and a metal-insulator-semiconductor-metal type one.

In addition, besides the above, the present invention is applicable similarly to the case of aiming at the achievement of lower resistance of wiring in a display apparatus in which two or more wiring and active devices are formed on a substrate. For example, it is applicable similarly also to a liquid crystal display equipped with thin film transistors (TFT) as active devices, and matrix wiring structure of a plasma display equipped with display electrodes.

It should be further understood by those skilled in the art that although the foregoing description has been made on embodiments of the invention, the invention is not limited thereto and various changes and modifications may be made without departing from the spirit of the invention and the scope of the appended claims.

1. A display apparatus having a plurality of first parallel wires formed on a substrate, a plurality of second parallel wires which intersects the first parallel wire, and a plurality of active devices connected to crossings of the first parallel wire and the second parallel wire, wherein either or both of the first parallel wire and the second parallel wire are constructed of sintered wire; and
wherein a sub-layer which includes a metal which constructs the sintered wire is formed in connection interfaces between the sintered wire and electrodes of the active devices.

2. The display apparatus according to claim 1, wherein sub-electrodes which are constructed of metal which constructs the sintered wire, or metal which includes the metal are provided for connection of the sintered wire and the electrodes of the active devices.

3. A display apparatus in which a plurality of cathodes provided on a substrate, feeding wire which is constructed of signal lines and scan lines for feeding the electrodes of the cathodes, and sub-electrodes for connecting the feeding wire and the electrodes of the cathodes are provided, wherein at least one side of the feeding wire is constructed of sintered wire, and connection interfaces between the sintered wire and sub-electrodes are metal films which include a metal which constructs the sintered wire.

4. The display apparatus according to claim 3, wherein the sub-electrodes are made of metal constructing sintered wire, or metal including the metal.

5. The display apparatus according to claim 4, wherein the sub-electrodes are made of metal including metal which constructs sintered wire, and metal which constructs electrodes of cathodes.

6. The display apparatus according to claim 4, wherein the sub-electrodes are made of metal including metal constructing sintered wire, and metal which resists the thermal oxidation.

7. The display apparatus according to claim 3, wherein the sub-electrodes are arranged as a layer lower than feeding wire which is constructed of the sintered wire.

8. The display apparatus according to claim 3, wherein the sub-electrodes are arranged as a layer upper than feeding wire, which is constructed of the sintered wire, so as to coat the sintered wire.

9. The display apparatus according to claim 3, wherein the feeding wire which is constructed of the sintered wire is signal lines for feeding electrodes of the cathodes.

10. The display apparatus according to claim 3, wherein the feeding wire which is constructed of the sintered wire is scan lines for feeding electrodes of the cathodes.

11. The display apparatus according to claim 1, wherein the sintered wire is made of low resistance metal such as Ag, Pd, Pt, or Au.

12. The display apparatus according to claim 5, wherein at least a part of electrodes of the cathodes are made of Al, or an Al alloy.

13. The display apparatus according to claim 6, wherein the metal which resists the thermal oxidation is Ni, Cr, Mo, Ti, Ta, W, or Co, or an alloy including it.

14. The display apparatus according to claim 1, wherein the sintered wire is constructed of wire sintered by heat treatment after formation of a wire pattern by screen printing using metal paste, an ink jet method using metal ink, or a photolithography method using photosensitive metal paste, and the sub-electrodes are constructed of electrodes performed pattern formation by photolithographic processing metal or an alloy film, formed by a vacuum film production method such as a sputtering method or a vacuum deposition, by a lithography method.

15. A display apparatus in which a plurality of cathodes provided on a substrate, feeding wire which is constructed of signal lines and scan lines for feeding the electrodes of the cathodes are provided, wherein at least one side of the feeding wire is constructed of sintered wire, and electrodes of the cathodes connected to the feeding wire is made of metal constructing the sintered wire, or metal including the metal.

16. The display apparatus according to claim 15, wherein the electrodes of the cathodes connected to the feeding wire are made of metal including metal constructing sintered wire, and metal which resists the thermal oxidation.

17. The display apparatus according to claim 15, wherein the electrodes of the cathodes are arranged as a layer lower than feeding wire which is constructed of the sintered wire.

18. The display apparatus according to claim 15, wherein the electrodes of the cathodes are arranged as an upper layer so as to coat the feeding wire which is constructed of the sintered wire.

19. The display apparatus according to claim 15, wherein the feeding wire which is constructed of the sintered wire is signal lines for feeding electrodes of the cathodes.

20. The display apparatus according to claim 15, wherein the feeding wire which is constructed of the sintered wire is scan lines for feeding electrodes of the cathodes.

21. The display apparatus according to claim 15, wherein the sintered wire is made of low resistance metal such as Ag, Pd, Pt, or Au.

22. The display apparatus according to claim 16, wherein the metal which resists the thermal oxidation is Ni, Cr, Mo, Ti, Ta, W, or Co, or an alloy including it.

23. The display apparatus according to claim 15, wherein the sintered wire is constructed of wire sintered by heat treatment after formation of a wire pattern by screen printing using metal paste, an ink jet method using metal ink, or a photolithography method using photosensitive metal paste, and the sub-electrodes are constructed of electrodes performed pattern formation by photolithographic processing metal or an alloy film, formed by a vacuum film production method such as a sputtering method or a vacuum deposition, by a lithography method.
